(19) United States
(12) Patent Application Publication
(10) Pub. No.: US 2026/0371318 A1
(43) Pub. Date: Nov. 19, 2026

(54) LOW-POWER TRANSMITTER SIGNALING FOR MACHINE LEARNING MODELS

(71) Applicant: QUALCOMM Incorporated, San Diego, CA (US)

(72) Inventors: Jung Ho RYU, Englewood Cliffs, NJ (US); Vasanthan RAGHAVAN, West Windsor Township, NJ (US)

(21) Appl. No.: 19/210,840

(22) Filed: May 16, 2025

(51) Int. Cl. H04W 72/044

(52) U.S. Cl. CPC H04W 72/044

(57) ABSTRACT

Certain aspects of the present disclosure provide techniques for wireless communications. An example method includes obtaining a signal comprising information, the information encoded in the signal based on an intrinsic property of the signal, the information comprising one or more of: beam management information or positioning information; and obtaining, via a machine learning model, a prediction result based on the information, the prediction result comprising one or more of: an indication of a beam associated with communications for a user equipment (UE) or a predicted position of the UE. Another example method includes obtaining the signal from an additional UE, where the information corresponds to the additional UE, such as the information comprising one or more of: beam management information for the additional UE or positioning information for the additional UE.

### INTRODUCTION

### Field of the Disclosure

Aspects of the present disclosure relate to wireless communications, and more particularly, to techniques for signaling to support machine learning (ML) models.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a signal comprising information, the information encoded in the signal based on an intrinsic property of the signal, the information comprising one or more of: beam management information or positioning information; and obtaining, via a machine learning model, a prediction result based on the information, the prediction result comprising one or more of: an indication of a beam associated with communications for the UE or a predicted position of the UE.

Certain aspects provide a method for wireless communications by a UE. The method includes obtaining, from an additional UE, a signal comprising information corresponding to the additional UE, the information comprising one or more of: beam management information for the additional UE or positioning information for the additional UE; and obtaining, via a machine learning model, a prediction result based on the information, the prediction result comprising one or more of: an indication of a beam associated with communications for the UE or a predicted position of the UE.

Certain aspects provide a method for wireless communications by a UE. The method includes obtaining a reference signal; and sending, via a low-power transmitter, a signal comprising information corresponding to the UE and associated with the reference signal, the information encoded in the signal based on an intrinsic property of the signal, the information comprising one or more of: beam management information associated with the reference signal or positioning information associated with the reference signal.

Certain aspects provide a method for wireless communications by a network entity. The method includes sending a reference signal; and sending control information comprising a plurality of time-frequency resources configured for communication via a low-power transmitter of a UE, the communication configured to be associated with the reference signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example artificial intelligence (AI) architecture that may be used for AI-enhanced wireless communications.

FIG. 6 depicts an example AI architecture of a first wireless device that is in communication with a second wireless device.

FIG. 7 illustrates example beam prediction by a UE.

FIG. 8 depicts an example of a UE architecture that supports low-power transceiver and main transceiver configurations.

FIG. 9 depicts an example wireless communications network.

FIG. 10 depicts an example wireless communications network for a position prediction based on signaling via low-power transmitters.

FIG. 11 depicts an example wireless communications network for a beam prediction based on signaling via low-power transmitters.

FIG. 12 depicts a process flow for communications in a network between a network entity, a UE, and one or more additional UEs.

FIG. 13 depicts a method for wireless communications.

FIG. 14 depicts another method for wireless communications.

FIG. 15 depicts another method for wireless communications.

FIG. 16 depicts another method for wireless communications.

FIG. 17 depicts aspects of an example communications device.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for low-power transmitter signaling for machine learning (ML) models.

A wireless communication system may include a number of devices and network entities employing techniques for exchanging information wirelessly. For example, a wireless communication system may include devices (e.g., user equipments (UEs)) and network entities (e.g., base stations (BS)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

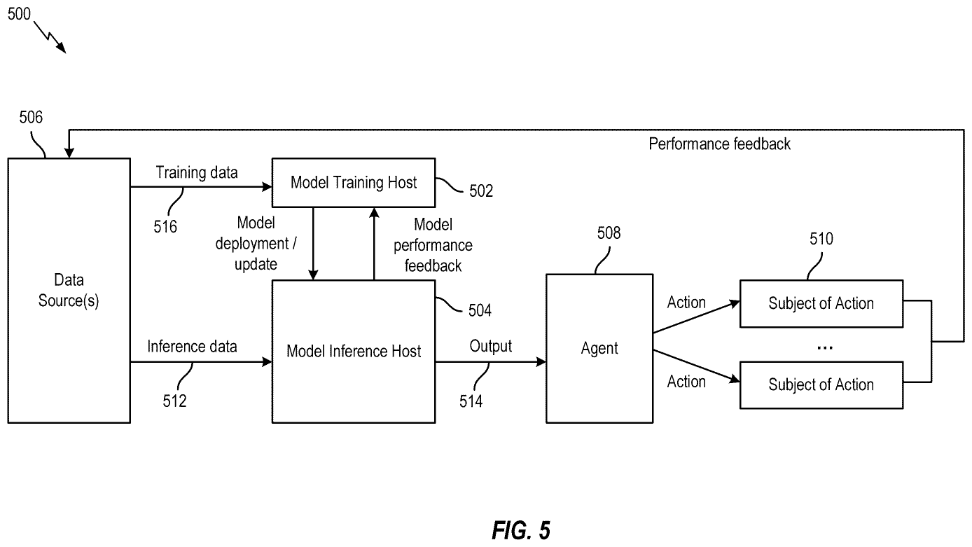

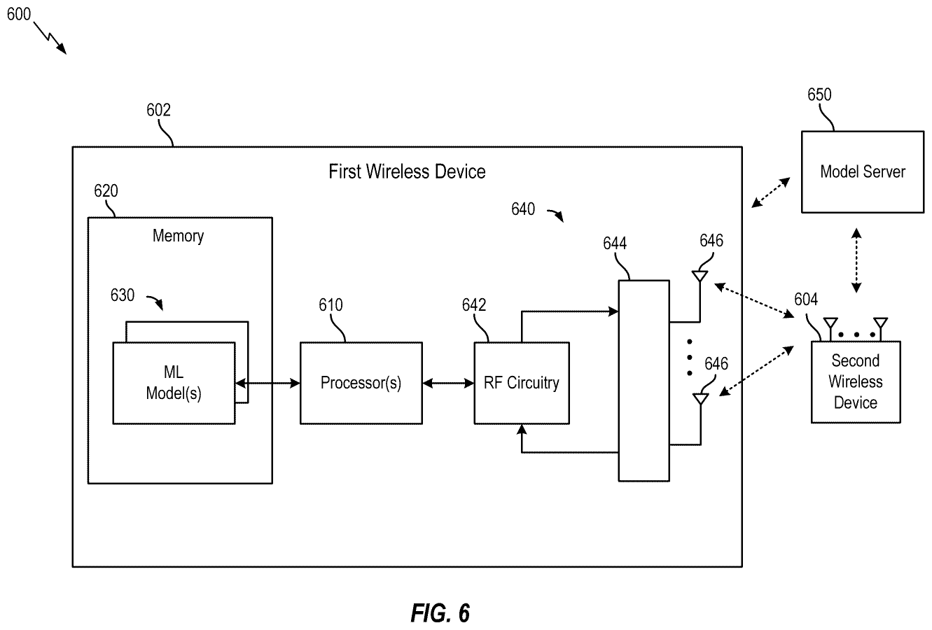

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data. ML models are described in greater detail with respect to FIGS. 5 and 6.

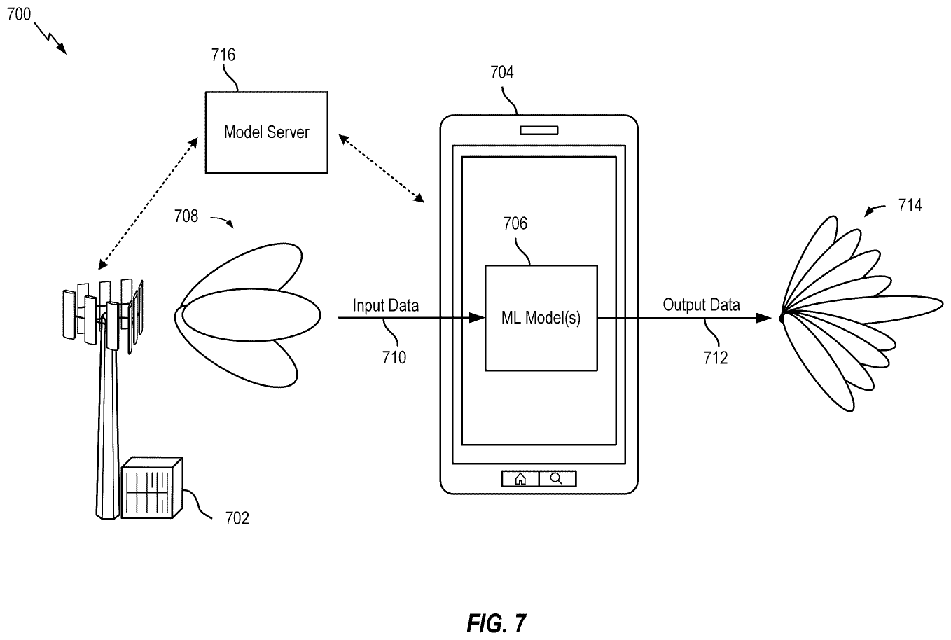

ML models may be deployed in one or more devices, such as network entities and/or UE(s), to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, positioning accuracy, transceiver tuning, beamforming, beam management, beam prediction, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like. An example implementation of an ML model for beam management (e.g., beam prediction(s)) is depicted and described in greater detail with respect to FIG. 7.

In some aspects, inputs to an ML model (e.g., input data) may include measurements of signals from the network. For example, a UE may perform measurements of signals sent via a first set of beams (e.g., coarse and/or wide beams) transmitted by a network entity and may input those measurements into an ML model to predict a beam from a second set of beams (e.g., refined and/or narrow beams) for subsequent communications with the network entity. Additionally or alternatively, a UE may perform measurements of reference signals transmitted by the network entity (e.g., downlink positioning reference signals (PRSs)) and may input those measurements into an ML model to predict a current position or location of the UE. However, in some cases, technical problems for ML models, for example, may include that the measurements of signals from the network solely being used as inputs to an ML model may not provide optimal outputs from the ML model for a device employing the ML model.

Aspects described herein may overcome the aforementioned technical problem(s), for example, by providing additional information that could potentially be used as inputs to an ML model (e.g., in addition or alternatively to measurements of signals from a network entity as described previously) to further enhance the ML model and/or provide more accurate or optimal outputs from the ML model. For example, signaling from nearby UEs to a UE that is employing an ML model could be leveraged and/or used as inputs to the ML model to provide more accurate outputs from the ML model. As an example, if the nearby UEs indicate to the UE employing the ML model that they are a certain distance from a reference point, then the UE employing the ML model may also likely be located near that same distance from the reference point, where the ML model may output that prediction based on the indications from the nearby UEs being used as inputs. Additionally or alternatively, if the UE employing the ML model receives indications from the nearby UEs that they are using a certain beam to connect to the network, then the UE employing the ML model may determine it should likely use that same beam to connect to the network, where the ML model may output this determination (e.g., beam prediction) based on the indications from the nearby UEs being used as inputs. In some cases, this signaling from the nearby UEs may consume a high amount of power at the nearby UEs for processing and sending the signaling, thereby reducing a battery life at the nearby UEs.

In some aspects, low-power receivers (e.g., as part of a low-power radio (LR) and/or low-power transceiver) may be used in various devices, such as a UE, to minimize energy consumption while maintaining the ability to receive signals. A low-power receiver may remain in a deep sleep state to consume minimal power and periodically wake up, for example, at predetermined times, to check if there are any incoming signals for the UE. The signals that a low-power receiver is capable of receiving may be different than the various signals that a main receiver (e.g., as part of a main radio and/or main transceiver) of the UE is capable of receiving. As an example of a low-power receiver, a UE may employ a low-power wake-up receiver (LP-WUR) that uses low amounts of power and remains operational during most or all of the time that the main receiver, main radio, and/or main system of the UE sleeps. For example, the LP-WUR may use less power to operate than the main receiver. In some aspects, the LP-WUR may be switched on and off quickly and may be capable of receiving and processing simple signals (e.g., limited bandwidth and simpler waveform). For example, the LP-WUR may receive a low-power wake-up signal (LP-WUS) from the network, thereby causing the UE to wake up (e.g., switch on the main receiver and/or main radio) and become fully or near fully operational again. That is, the UE may shut down its main receiver and/or main radio to save power and monitor for the LP-WUS using the LP-WUR for a wake-up signal (WUS) from the network. Subsequently, if the UE receives the LP-WUS (e.g., via the LP-WUR), the UE may switch on its main receiver and/or main radio and may start monitoring for downlink channels (e.g., physical downlink control channels (PDCCHs)) for control signaling from the network. In some aspects, the LP-WUS may include an on-off keying (OOK) waveform.

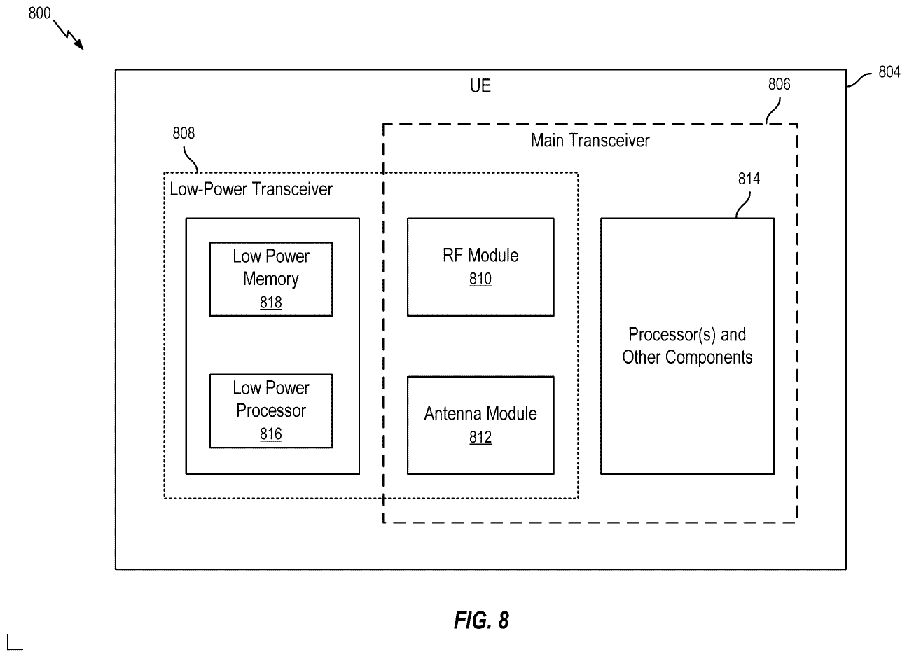

Similar to the low-power receivers (e.g., LP-WURs), various devices, such as a UE, may include and use a low-power transmitter (e.g., as part of an LR and/or low-power transceiver) to minimize energy consumption while maintaining the ability to transmit signals. In some aspects, the low-power transmitter may include or may be referred to as a wake-up transmitter (WUT) and/or low-power WUT (LP-WUT). The low-power transmitter does not mean that the UE transmits at a low transmit power. Rather, with the low-power transmitter, the UE may transmit at various transmit powers, but the UE may use less overall power with the low-power transmitter compared to a main transmitter (e.g., as part of the main radio and/or main transceiver). The low-power transmitter may be capable of transmitting simple, pre-processed signals with a limited bandwidth. The low-power transmitter is depicted and described in greater detail with respect to FIG. 8.

Technical problems for signaling, such as with low-power transmitters, for example, may include limited processing, memory, and/or transmission capabilities, such as relative to a main transmitter of a UE. As described previously, signaling from nearby UEs to a UE that is employing an ML model could be leveraged and/or used as inputs to the ML model to provide more accurate outputs from the ML model, but this signaling from the nearby UEs may be complex and/or consume a high amount of power at the nearby UEs. As such, the nearby UEs may transmit the signaling via lower complexity signaling, such as using low-power transmitters, such as to reduce their power consumption and/or processing complexity for processing and sending the signaling. For example, a low-power transmitter may perform simple, pre-processed signal transmissions whereas a main transceiver may perform more complex transmissions using sophisticated modulation, coding, precoding, or the like. Therefore, techniques for generation and transmission of certain signaling, such as via a main transceiver, may be complex, such as exceed capabilities of the low-power transmitter, and may impact supported transmission types, memory usage, or processor usage.

Aspects described herein may overcome the aforementioned technical problem(s), for example, by providing signaling from nearby UEs, such as via low-power transmitters, to a UE that is employing an ML model, where the nearby UEs encode information in the signaling based on an intrinsic property of the signaling, and the encoded information can be used as inputs to the ML model. That is, one or more UEs, such as that are equipped with low-power transmitters, may transmit signals, such as via the low-power transmitters, to enable the UE to employ the ML model based on information encoded within the signals. In some aspects, the signals may be pre-generated and preprocessed and stored in memory as a waveform in the one or more UEs, which may reduce processing complexity, such as to support the use of the low-power transmitters. For example, the signals may be sequence-based, such as a Zadoff Chu or Golay sequence, and the one or more UEs may convey the information to be used as inputs to the ML model based on an intrinsic property of the sequence-based signal. As described herein, an “intrinsic property” may include a property of the construction or structure of a signal and may be different than other properties of the signal, such as measurements and/or qualities of the signal.

In some aspects, the intrinsic property of the sequence-based signal may include a cyclic shift or a root sequence index, where the cyclic shift or root sequence index may be used to encode and/or convey the information in the signal. Additionally or alternatively, the one or more UEs may encode the information based on a different intrinsic property of the signals, such as which time and/or frequency resources are used to carry the signals, a waveform shape of the signals, etc. In some aspects, a network entity may indicate, to the one or more UEs and the UE that is employing the ML model, an association (e.g., mapping) of different signal properties and the information conveyed based on those different signal properties. In some aspects, the network entity may also indicate time-frequency resources for the signals (e.g., for the one or more UEs to transmit the signals and for the UE that is employing the ML model to receive the signals).

Accordingly, the UE that is employing the ML model may obtain a prediction result from the ML model based on inputting the encoded information from the signal into the ML model. As an example, the signals may indicate respective distances that each UE of the one or more UEs are from a reference point (e.g., the indications of the respective distances are encoded in the signals based on the intrinsic properties of the signals), and the UE that is employing the ML model may input the respective distances into the ML model to obtain a predicted position of the UE output by the ML model. Additionally or alternatively, the signals may indicate respective beams that each UE of the one or more UEs uses to connect with a network entity (e.g., the indications of the respective beams are encoded in the signals based on the intrinsic properties of the signals), and the UE that is employing the ML model may input the indications of the respective beams into the ML model to obtain an indication of a beam (e.g., beam prediction) output by the ML model to use to connect with the network entity. In some aspects, the one or more UEs may indicate other types of information than respective distances and/or respective beams to the UE that is employing the ML model (e.g., by encoding the other types of information in the signals based on the intrinsic properties of the signals), and the UE that is employing the ML model may or may not input the other types of information into the ML model to obtain a prediction result output by the ML model.

Certain techniques for providing signaling, such as via low-power transmitters, for obtaining a prediction result from an ML model described herein may provide various beneficial technical effects and/or advantages. The techniques for signaling may enable improved wireless communications performance, such as reduced power consumption at UEs that are sending the signaling. For example, generating such signaling may consume less power at the UEs compared to complex signaling. Additionally or alternatively, the techniques for obtaining a prediction result from the ML model (e.g., based on the signaling via the low-power transmitters) may enable improved wireless communications performance at a UE employing the ML model, such as reduced latency and increased throughput. For example, the prediction result from the ML model may include an indication of a beam associated with communications for the UE employing the ML model based on the signaling, where using the beam from the indication may result in reduced latency and/or increased throughput for the UE. Additionally or alternatively, the prediction result from the ML model may include a predicted position of the UE, which may enhance and/or enable different technologies for the UE, such as Internet of Things (IoT) systems, autonomous driving, etc.

### Introduction to Wireless Communications Networks

The techniques and methods described herein may be used for various wireless communications networks. While aspects may be described herein using terminology commonly associated with 3^{rd} generation (3G), 4^{th} generation (4G), 5^{th} generation (5G), 6^{th} generation (6G), and/or other generations of wireless technologies, aspects of the present disclosure may likewise be applicable to other communications systems and standards not explicitly mentioned herein.

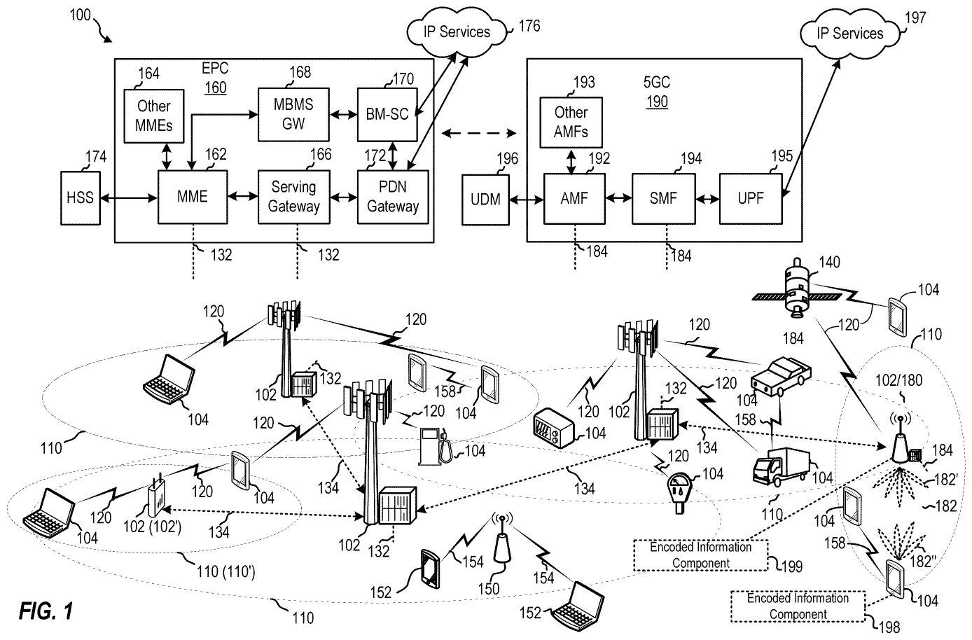

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a UE, a BS, a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency (RF) characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

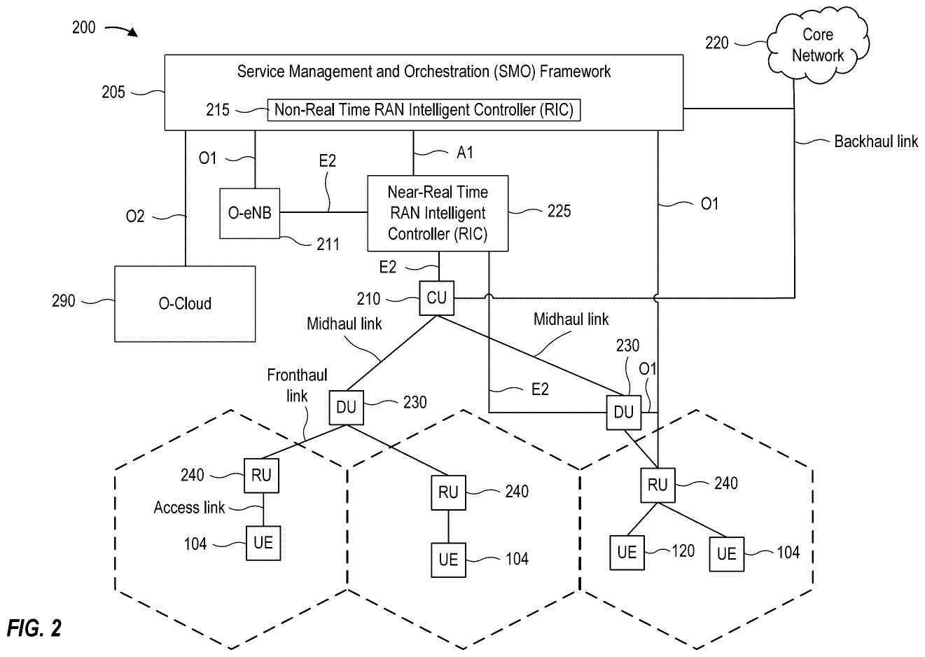

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G Long-Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G New Radio (NR) or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3^{rd} Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave RF bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes an encoded information component 198, which may be used to send and/or obtain encoded information within signaling sent via low-power transmitters as further described herein. Further, a BS 102 includes an encoded information component 199, which may be used to configure and indicate resources for a UE 104 to send and/or obtain encoded information within signaling sent via low-power transmitters as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more RF access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

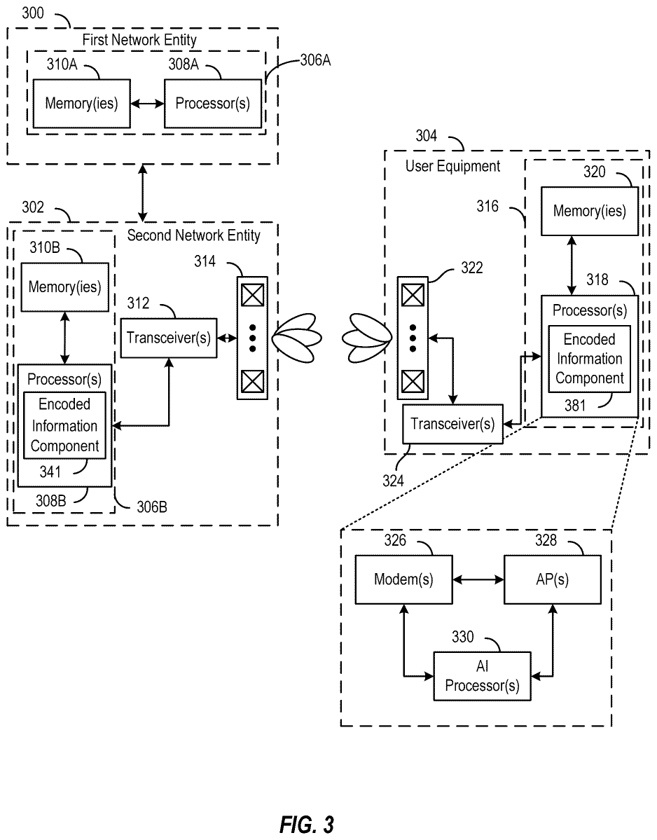

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306A” at first network entity 300 and “processing system 306B” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308A” and “processor(s) 308B”) and one or more memories 310 (illustrated as “memory(ies) 310A” and “memory(ies) 310B”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more RF components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmit (TX) MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receive (RX) MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for single-carrier frequency division multiplexing (SC-FDM)), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306B such as a modem and/or an RX MIMO detector), and further processed by the processing system 306B (e.g., a modem and/or a receive processor) to obtain decoded data and control information sent by UE 304. The processing system 306B may provide the decoded data and the decoded control information (such as to a controller/processor of the processing system 306B, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308B includes an encoded information component 341, which may be representative of the encoded information component 199 of FIG. 1. Notably, while depicted as an aspect of processor(s) 308B, the encoded information component 341 may be implemented additionally or alternatively in various other aspects of a network entity or a BS 102 in other implementations. Further, the processor(s) 318 includes an encoded information component 381, which may be representative of the encoded information component 198 of FIG. 1. Notably, while depicted as an aspect of the processor(s) 318, the encoded information component 381 may be implemented additionally or alternatively in various other aspects of a UE 104 in other implementations.

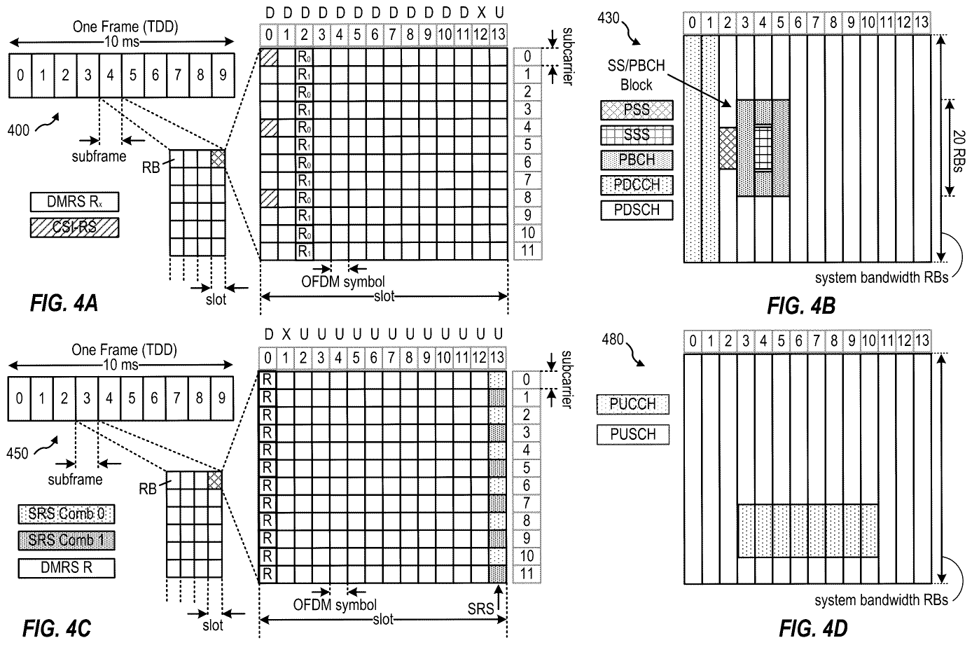

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgment (ACK)/negative acknowledgment (NACK) feedback. The PUSCH carries data, and may additionally be used to carry a buffer status report (BSR), a power headroom report (PHR), and/or UCI.

### Example Machine Learning/artificial Intelligence for Wireless Communications

Aspects described herein may describe the performance of certain tasks and the technical solution of various technical problems by application of a specific type of ML model, such as an artificial neural network (ANN). It should be understood, however, that other type(s) of ML models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508. In certain aspects, the model inference host 504 may be an example of a model inference agent.

The agent 508 may be an element or an entity of a wireless communication system including, for example, a radio access network (RAN), a wireless local area network, a device-to-device (D2D) communications system, etc. In certain examples, the agent 508 may be an example of a decision agent. In some examples, the agent 508 may be a UE, a base station, or any disaggregated network entity thereof including a CU, a DU, and/or an RU, an access point, a wireless station, a RIC in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management and/or positioning, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with beam management, the agent 508 may determine whether to change or modify a transmit and/or receive beam based on the output 514. For example, if agent 508 is a DU or an RU and the output from model inference host 504 is associated with positioning, the agent 508 may perform one or more location based tasks based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE). As another example, the agent 508 may be a UE, the output 514 from model inference host 504 may be one or more predicted channel characteristics for one or more beams. For example, the model inference host 504 may predict channel characteristics for a set of beams based on the measurements of another set of beams. Based on the predicted channel characteristics, the agent 508, such as the UE, may send, to the subject of action 510, such as a BS, a request to switch to a different beam for communications. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration or position from agent 508, the subject of action 510 may provide performance feedback associated with the beam configuration or position to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model is deployed at or on a UE (e.g., such as UE 104 in FIG. 1) for position predictions and/or beam predictions. More specifically, a model inference host, such as model inference host 504 in FIG. 5, may be deployed at or on the UE for obtaining a predicted position of the UE and/or for obtaining an indication of a beam (e.g., beam prediction) to use to connect with a network entity.

FIG. 6 illustrates an example AI architecture 600 of a first wireless device 602 that is in communication with a second wireless device 604. The first wireless device 602 may be an example of UE 104 depicted and described with respect to FIG. 1 or the UE 304 depicted and described with respect to FIG. 3. Similarly, the second wireless device 604 may be an example of the BS 102 depicted and described with respect to FIG. 1, the first network entity 300 or the second network entity 302 depicted and described with respect to FIG. 3, a disaggregated base station depicted and described with respect to FIG. 2. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes RF circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the model inference host 504 of FIG. 5. The ML model 630 may be used to perform any of various AI-enhanced tasks, such as those listed above.

As an example, the ML model 630 may take measurements of a reference signal (e.g., corresponding to a wide beam) as input to predict a channel characteristic associated with a different reference signal (e.g., corresponding to a narrow beam within the wide beam, another wide beam, a narrow beam outside the wide beam, etc.). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, one or more predicted measurements (or characteristics) of one or more reference or pilot signals, which may be different from the reference or pilot signals associated with the input data. In certain aspects, the one or more reference or pilot signals for which the one or more measurements are predicted may be considered “virtual resources” in they are not actually transmitted, but the measurements are predicted as though they were transmitted. In certain aspects, the one or more reference or pilot signals for which the one or more measurements are predicted may actually be transmitted but not actually measured by first wireless device 602.

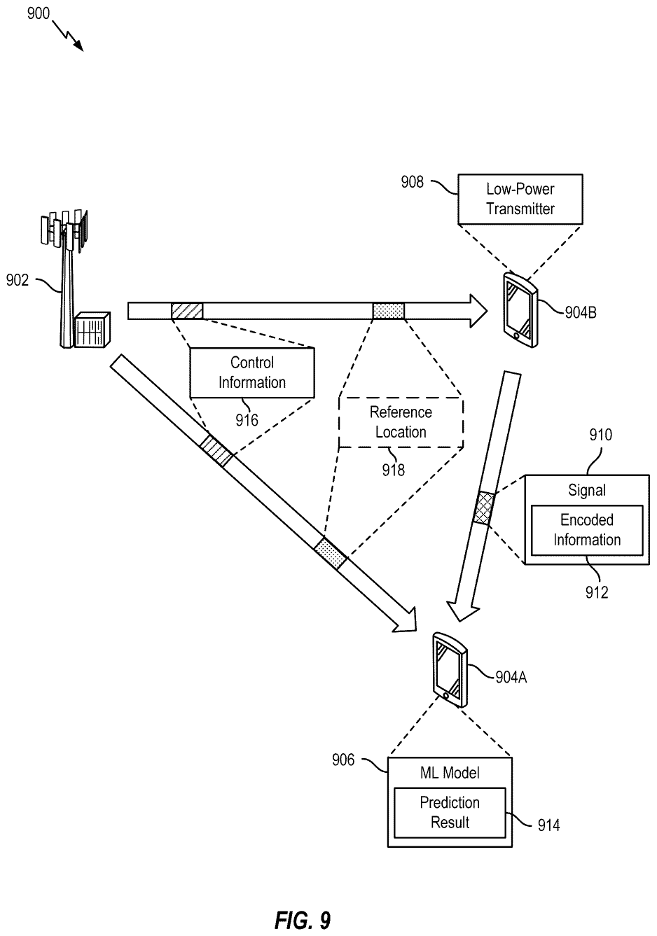

Note that other input data and/or output data may be used in addition to or instead of the examples described herein. For example, as described herein and in greater detail with respect to FIG. 9-11, the ML model 630 may take information obtained from additional devices as input(s) to predict an output. In some aspects, the first wireless device 602 may obtain information and/or signaling from one or more additional devices (e.g., one or more UEs) nearby the first wireless device 602. Subsequently, the first wireless device 602 may input this information from the additional device(s) into the ML model 630 to obtain an output that is based on the information. As an example described herein, each of the additional device(s) may send (e.g., broadcast) positioning information for themselves, where the first wireless device 602 inputs the positioning information into the ML model 630 (e.g., along with measurements and/or other information determined at the first wireless device 602) to obtain a predicted position of the first wireless device 602 based on the positioning information from each of the additional device(s). Additionally or alternatively, each of the additional device(s) may send (e.g., broadcast) beam management information for themselves, where the first wireless device 602 inputs the beam management information into the ML model 630 (e.g., along with measurements and/or other information determined at the first wireless device 602) to obtain a beam management prediction (e.g., indication of a beam associated with communications for the first wireless device 602) of the first wireless device 602 based on the beam management information from each of the additional device(s).

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Aspects of ML Model Training

There are a variety of model training techniques and processes that may be used prior to, or at some point following, deployment of an ML model.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more UEs, one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ML model, parameters affecting the functioning of the artificial neurons and layers may be adjusted. For example, backpropagation techniques may be used to train the ML model by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a UE or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a CU, a DU, an RU, or the like.

As an example, AI/ML techniques have been introduced to help reduce the complexity involved in beam selection and the overhead associated with beam management without sacrificing system performance. For example, with the help of ML techniques, beam selection may be performed in a fraction of the time taken by conventional exhaustive search methods and with performance comparable to that of such methods.

Certain wireless communication systems (e.g., a 5G NR system and/or any future system) may use beamforming for directional signal transmission and/or reception to facilitate efficient and reliable wireless communications. As an example, beamforming may apply various amplitude weighting and/or phase shift patterns across multiple antennas to focus transmission or reception of wireless signals in a particular spatial direction (e.g., azimuth and/or elevation) and/or beamwidth generally defining a beam. The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

In some aspects, efficient and reliable communications may be achieved through various beam management techniques such as beamforming, beam selection (e.g., the process of selecting a beam to use for wireless communications), beam failure detection procedure(s) (e.g., the process of detecting when communications via a beam do not meet a quality or reliability specification, such as a particular data error rate), beam failure recovery procedure(s) (e.g., the process of selecting an alternative beam when beam failure is detected for a particular beam used for communications), or the like. Such beam management techniques may be critical to achieving the high data rates, low latency, and/or high reliability that various generations of wireless technologies promise to deliver.

In certain cases, beam management may be enabled through certain AI-based beam predictions, such as spectral beam predictions, temporal beam predictions, and/or spatial beam predictions. For example, an ML model is deployed at or on a UE (e.g., such as UE 104 in FIG. 1), such as for purposes of spatial domain (SD), temporal domain (TD), and/or frequency domain (FD) beam prediction. The TD refers to the analytic space in which signals are conveyed in terms of time. The FD refers to the analytic space in which signals are conveyed in terms of frequency. A scenario where the ML model, at or on the UE, is used to predict SD downlink beams for a set of A-beams (referred to as “Set-A beams”) based on measurement results of a set of B-beams (referred to as “Set-B beams”) may be referred to as a beam management case 1, or simply “BM-Case1.” Additionally, a scenario where the ML model, at or on the UE, is used to predict TD downlink beams for Set-A beams based on the historic measurement results of a set of B-beams may be referred to as a beam management case 2, or simply “BM-Case2.” In general, ML may be used to predict characteristics associated with the Set-A beams, and the set of B-beams may be used for DL beam measurements as input data for the ML. For BM-Case1 and BM-Case2, the beams in the Set-A beams and the set of B-beams may be in the same Frequency Range (e.g., FR1 and/or FR2). In some cases, the set of B-beams may be a subset of the Set-A beams. There may be any number of beams in each of the Set-A beams and the set of B-beams. There may be quasi-colocation (QCL) relationships between the Set-A beams and the set of B-beams.

FIG. 7 is a diagram illustrating example beam prediction 700 by a UE. In this example, one or more ML models (hereinafter “the ML model 706”) are deployed at or on the UE 704 to enable the UE 704 to make one or more beam predictions based on data input to ML model 706. The UE 704 may be an example of UE 104 depicted and described with respect to FIG. 1, the UE 304 depicted and described with respect to FIG. 3, or the first wireless device 602 depicted and described with respect to FIG. 6.

A network node 702 (e.g., a base station or any disaggregated entity thereof) may transmit one or more signals (e.g., SSB(s), DMRS(s), CSI-RS(s)), via a first set of transmit beams 708, in a first set of communication resources (e.g., an SSB resource, a DMRS resource, and/or a CSI-RS resource). The network node 702 may be an example of the BS 102 depicted and described with respect to FIG. 1, the first network entity 300 or the second network entity 302 depicted and described with respect to FIG. 3, a disaggregated base station depicted and described with respect to FIG. 2, or the second wireless device 604 depicted and described with respect to FIG. 6.

The UE 704 may perform measurements (e.g., L1-RSRP measurements and/or other measurements) of the one or more signals transmitted in the first set of communication resources, or a subset thereof, to obtain input data, which may include a first set of measurements 710 (sometimes referred to as parameters, channel characteristics, or channel properties). For example, each transmit beam (or a subset thereof), from the first set of transmit beams 708 carrying the signal(s), may be associated with one or more measurements 710 performed by UE 704. The UE 704 may feed the first set of measurements 710 (e.g., L1 RSRP measurement values) into the ML model 706. The UE 704 may further feed information associated with the first set of beams and/or first set of communication resources (or a subset thereof). The information associated with the first set of beams may include a beam direction (e.g., a spatial direction), beam width, beam shape, and/or other characteristics of the respective beam. In one example, a first set of measurements 710 may be associated with a given transmit beam of network node 702 and a given receive beam of UE 704. UE 704 may feed the first set of measurements 710 and information associated with the first set of measurements 710 into ML model 706. The information associated with the first set of measurements 710 may include a transmit beam identifier of a transmit beam of the network node 702 used to transmit one or more signals measured by UE 704 to generate the first set of measurements 710. In certain aspects, the information associated with the first set of measurements 710 may include a receive beam identifier of a receive beam of the UE 704 used by UE 704 to measure the first set of measurements 710, such as where ML model 706 further is configured to take the receive beam identifier as input.

The ML model 706 may provide output data, for example, including an indication of a second set of measurements 712. As part of AI-based beam prediction, the second set of measurements 712 may include one or more predicted measurement values for a second set of communication resources associated with a second set of transmit beams 714. As an example, the second set of measurements 712 may include one or more predicted channel characteristics (e.g., predicted L1-RSRP measurement values) associated with the second set of communication resources, where the second set of communication resources are associated with the second set of transmit beams 714. In certain cases, the UE 704 may perform measurements of one or more signals transmitted in the second set of communication resources, or a subset thereof, to obtain the second set of measurements 712, for example, as a part of training data collection and/or performance monitoring for the ML model 706. In another example, ML model 706 may provide output data, for example, including a transmit beam identifier of a transmit beam (e.g., second set of transmit beams 714) of network node 702, such as that UE 704 predicts should be used for communication between UE 704 and network node 702.

In some examples, the first set of transmit beams 708 (e.g., that are measured) may be referred to as “Set-B beams” and the second set of transmit beams 714 (e.g., that are associated with predicted measurements for the second set of communication resources) may be referred to as “Set-A beams.” Put another way, the “Set-B beams” are a set of beams for which measurements are taken and used to determine input data based on such measurements for the ML model 706, whereas the “Set-A beams” are a set of beams for which ML model 706 performs predictions.

In some examples, the first set of transmit beams 708 are a subset of the second set of transmit beams 714. In some other examples, the first set of transmit beams 708 and the second set of transmit beams 714 are different beams and/or may be mutually exclusive sets. For example, the first set of transmit beams 708 may include wide beams (e.g., unrefined beams or beams having a beam width that satisfies a first threshold), and the second set of transmit beams 714 may include narrow beams (e.g., refined beams or beams having a beam width that satisfies a second threshold).

Use of the ML model 706 for beam prediction may reduce a quantity of beam measurements that are performed by the UE 704 (e.g., compared to exhaustive search methods described above with respect to FIG. 5), thereby conserving power at the UE 704 and/or network resources that would have otherwise been used to measure all beams included in at least the first set of beams.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the ML model 706 may include a point-direction, an angle of departure (AoD), and/or an angle of arrival (AoA) of a beam included in the second set of transmit beams 714 (e.g., the “Set-A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to the ML model 706. This may enable the ML model 706 to output codebook-based and/or non-codebook-based predictions for a measurement value, an AoD, and/or an AoA, among other examples, of a beam at a future time. The output(s) of the ML model 706, may facilitate initial access procedures, carrier aggregation (e.g., secondary cell setup), dual connectivity (e.g., secondary cell group (SCG) setup), beam refinement procedures, link quality or interference adaptation procedures, beam failure and/or beam blockage predictions, and/or radio link failure predictions, among other examples.

In certain aspects, an output of the ML model 706 may include a temporal beam prediction, such as a TD beam prediction. The TD beam prediction may be associated with a serving beam refinement, a link quality (e.g., CQI or PMI) and interference adaptation, a beam failure/blockage prediction, and/or a radio link failure (RLF) prediction.

In certain aspects, the ML model 706 performs SD downlink beam predictions for beams included in the “Set-A beams” based on measurement results of beams included in the “Set-B beams.” In some aspects, the ML model 706 performs TD downlink beam prediction for beams included in the “Set-A beams” based on historic measurement results of beams included in the “Set-B beams.”

In certain aspects, a model server 716 (in communication with the UE 704 and/or the network node 702) may perform any of various ML model lifecycle management (LCM) tasks for the UE 704 and/or the network node 702. The model server 716 may operate as the model training host 502 (e.g., depicted and described with respect to FIG. 5) and update the ML model 706 using training data. In some cases, the model server 716 may operate as the data source 506 (e.g., depicted and described with respect to FIG. 5) to collect and host training data, inference data, and/or performance feedback associated with an ML model 706. In certain aspects, the model server 716 may host various types and/or versions of the ML model 706 for the UE 704 and/or the network node 702 to download.

In some cases, the model server 716 may monitor and evaluate the performance of the ML model 706 to trigger one or more LCM tasks. For example, the model server 716 may determine whether to activate or deactivate the use of a particular ML model at the UE 704 and/or the network node 702, and the model server 716 may provide such an instruction to the respective UE 704 and/or the network node 702. In some cases, the model server 716 may determine whether to switch to a different ML model 706 being used at the UE 704 and/or the network node 702, and the model server 716 may provide such an instruction to the respective UE 704 and/or the network node 702. In yet further examples, the model server 716 may also act or operate as a central server for decentralized machine learning tasks, such as federated learning.

### Aspects Related to UE Architecture for a Low-Power Transceiver Configuration

FIG. 8 depicts an example 800 of a UE architecture that supports low-power transceiver and main transceiver configurations. The example 800 illustrates UE 804, which may be an example of the UE 104 depicted and described with respect to FIG. 1, the UE 304 depicted and described with respect to FIG. 3, the first wireless device 602 depicted and described with respect to FIG. 6, or the UE 704 depicted and described with respect to FIG. 7. In some aspects, the UE 804 may be another type of a UE or a wireless communications device, such as those referenced and described herein.

As depicted, the UE 804 has two transceivers—a main transceiver 806 and a low-power transceiver 808. The main transceiver 806 and the low-power transceiver 808 may share some components, such as RF module 810 and antenna module 812, for example, to reduce the cost of the UE 804. These shared components may be used by the low-power transceiver 808 at reduced capabilities, for example, to further decrease power use by the UE 804. In certain implementations, the main transceiver 806 and the low-power transceiver 808 may be implemented for a same modem and use a same protocol stack.

The main transceiver 806 includes or utilizes processor(s) and other components 814. The other components may include one or more memories that may be coupled to one or more processors. The UE 804 may switch off the one or more processors and other components of the main transceiver 806.

As depicted, the low-power transceiver 808 includes or utilizes a low-power processor 816 (e.g., limited processor) and a low-power memory 818 (e.g., limited memory). In some aspects, the one or more processors and one or more memories included in the low-power processor 816 and low-power memory 818 may be examples of or configurations of, respectively, the one or more processors 318 and the one or more memories 320 described with respect to FIG. 3. The low-power processor 816 may be less complex and/or may use less power than the one or more processors included in the processor(s) and other components 814 used for the main transceiver 806. In some aspects, the one or more processors and one or more memories included in the processor(s) and other components 814 may be examples of or configurations of, respectively, the one or more processors 318 and the one or more memories 320 described with respect to FIG. 3.

The low-power processor 816, as a part of low-power transceiver 808, has limited, simple capabilities, including frequency and time synchronization, RSRP measurements, etc. To implement power saving advantages, the low-power transceiver 808 may store signal representations to effectuate signal transmission in the low-power memory 818. The low-power memory 818 may also be an example or the one or more memories 320 described with respect to FIG. 3.

These signal representations correspond to pre-generated and/or preprocessed signals from a sequence or base signal, and stored in the low-power memory 818 as a waveform construct (e.g., store in-phase and quadrature (I/Q) samples as complex numbers). The pre-generated and/or preprocessed signals stored in the low-power memory 818 may be sent directly to the RF module 810 and antenna module 812 for transmission. That is, for example, pre-generated and/or preprocessed signals and waveforms are those that have been created and stored in advance, rather than being generated on demand. It is to be appreciated that the waveforms based on a sequence (e.g., a Zadoff Chu (ZC) sequence, Golay sequence, m-sequence, etc.) or base signal to be transmitted using the low-power transceiver 808 have simple enough constructs to be pre-generated and stored in the low-power memory 818, in accordance with certain implementations. Thus, these waveforms may be transmitted without activating the processor(s) and other components 814. In some aspects, these waveforms and/or pre-generated/preprocessed signals may be unmodulated signals.

When operating in a low-power transceiver mode, the UE 804 may deactivate the main transceiver 806 and/or the processor(s) and other components 814, thereby saving power. In the low-power transceiver mode, the low-power transceiver 808 may be operational and provide encoded information for the UE 804 using the capabilities afforded by the low-power processor 816 and the low-power memory 818.

In some implementations, however, the main transceiver 806 and the low-power transceiver 808 may be implemented as power configuration modes (e.g., a main-power transceiver mode and a low-power transceiver mode) using the same transceiver components (e.g., processor(s) and other components 814 may include the low-power processor 816 and the low-power memory 818), not as depicted in FIG. 8. In this manner, the UE 804 may operate in different power configuration modes rather than using different transceiver circuitry to effectuate the low-power transceiver mode.

### Aspects Related to Signaling Encoded Information via Low-power Transmitters

FIG. 9 depicts an example wireless communications network 900 that supports signaling encoded information via low-power transmitters in accordance with aspects of the present disclosure. In some examples, the wireless communications network 900 may implement aspects of or may be implemented by aspects of FIGS. 1-8. For example, the wireless communications network 900 may include a network entity 902, a first UE 904A, and a second UE 904B. The network entity 902 may be an example of the BS 102 depicted and described with respect to FIG. 1, the first network entity 300 or the second network entity 302 depicted and described with respect to FIG. 3, a disaggregated base station depicted and described with respect to FIG. 2, the second wireless device 604 depicted and described with respect to FIG. 6, or the network node 702 depicted and described with respect to FIG. 7. The first UE 904A and the second UE 904B may be examples of the UE 104 depicted and described with respect to FIG. 1, the UE 304 depicted and described with respect to FIG. 3, the first wireless device 602 depicted and described with respect to FIG. 6, the UE 704 depicted and described with respect to FIG. 7, or the UE 804 depicted and described with respect to FIG. 8.

In the example of FIG. 9, the first UE 904A may include and/or employ an ML model 906 to obtain prediction results for the first UE 904A. In some aspects, the ML model 906 may be an example of the model inference host 504 depicted and described with respect to FIG. 5, the ML model 630 depicted and described with respect to FIG. 6, or the ML model 706 depicted and described with respect to FIG. 7. The ML model 906 may include an AI/ML module loaded into the first UE 904A and/or accessed by the first UE 904A. Additionally, in the example of FIG. 9, the second UE 904B may include a low-power transmitter 908 to minimize energy consumption while maintaining the ability to transmit signals. In some aspects, the low-power transmitter 908 may be an example of the low-power transceiver 808 depicted and described with respect to FIG. 8. In some aspects, the second UE 904B may send a message to the network entity 902 to indicate a capability of the second UE 904B to send signaling via the low-power transmitter 908 and/or to indicate that the second UE 904B is equipped with the low-power transmitter 908.

In some aspects, the ML model 906 may be used for beam management (e.g., the beam prediction 700 depicted and described with respect to FIG. 7) and/or positioning accuracy (e.g., predicted positions) for the first UE 904A. Inputs to the ML model 906 for the beam management and/or positioning accuracy may include measurements of signals received by the first UE 904A from the network entity 902. As described herein, the first UE 904A may also or alternatively use information sent by nearby UEs (e.g., the second UE 904B) via low-power transmitters of the nearby UEs as inputs into the ML model 906. With the low-power transmitters, UEs that are in a low-power mode may transmit information that help the first UE 904A with prediction and/or accuracy enhancements for the ML model 906.

As shown in the example of FIG. 9, the second UE 904B may send a signal 910 using the low-power transmitter 908. In some aspects, the second UE 904B may broadcast the signal 910. In some aspects, the second UE 904B may send the signal 910 periodically, where the periodicity with which the second UE 904B sends the signal 910 may be predefined (e.g., in wireless communications standards) and/or may be indicated by the network entity 902. The signal 910 may include encoded information 912 that the first UE 904A can use for beam management and/or positioning accuracy enhancements using the ML model 906. In some aspects, the signal 910 may be sequence-based. For example, the signal 910 may include a Zadoff Chu or Golay sequence. Accordingly, the second UE 904B may encode and/or convey information in the signal 910 using an intrinsic property of the sequence for the signal 910. For example, cyclic shifts or root sequence index of Zadoff Chu sequence may be used to encode and/or convey information in the signal 910. In some aspects, the signal 910 may be unmodulated.

The encoded information 912 within the signal 910 may include different types of information from the second UE 904B for the beam management and/or for the positioning accuracy enhancements using the ML model 906 at the first UE 904A. For example, for the beam management (e.g., beam prediction), the second UE 904B may indicate beam management information of which beam (e.g., SSB beam) the second UE 904B is using to connect to its serving network entity (e.g., the network entity 902) and which serving network entity to which the second UE 904B is connecting using the encoded information 912 within the signal 910. For the positioning accuracy enhancement, the second UE 904B may indicate positioning information of how far the second UE 904B is from a reference point using the encoded information 912 within the signal 910. In some aspects, the second UE 904B may use an ML model (e.g., not illustrated in the example of FIG. 9) to determine what to send via the encoded information 912 within the signal 910, such as location coordinates of the second UE 904B and/or which beam the second UE 904B is using to connect to the network entity 902.

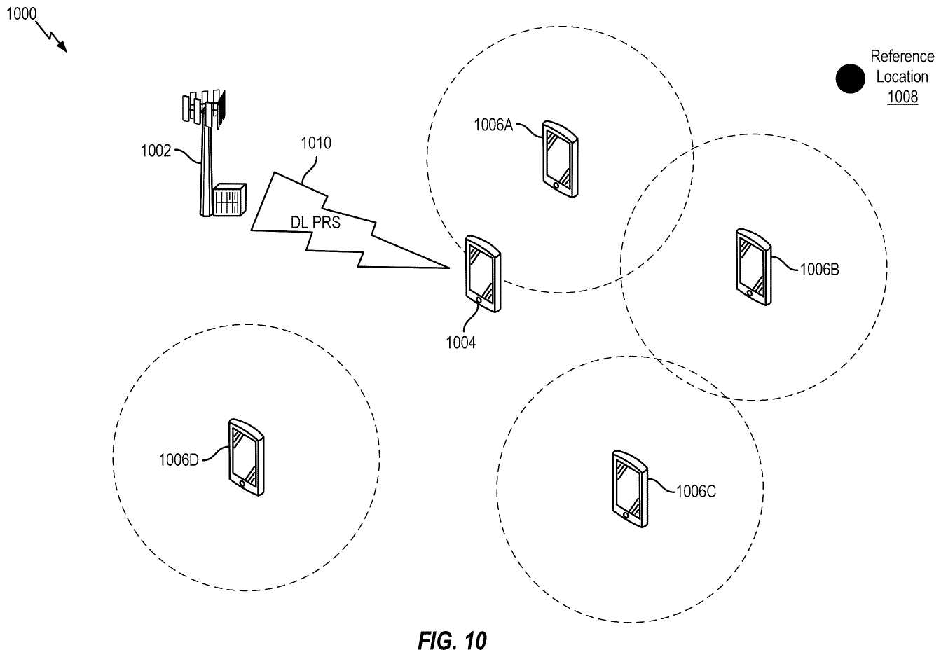

Subsequently, the first UE 904A may obtain the signal 910 from the second UE 904B. In some aspects, the first UE 904A may obtain the signal 910 via a LP-WUR or a main receiver. The first UE 904A may extract the encoded information 912 and use the extracted information as an input to the ML model 906 to obtain a prediction result 914. In some aspects, the prediction result 914 may include a predicted position of the first UE 904A. For example, if the second UE 904B indicates it is a certain distance from the reference point via the encoded information 912 in the signal 910 and the second UE 904B is nearby the first UE 904A, then the predicted position from the prediction result 914 may also indicate that the first UE 904A is likely to be that same distance or near that same distance from the reference point. The predicted position for the prediction result 914 is depicted and described in greater detail with respect to FIG. 10.

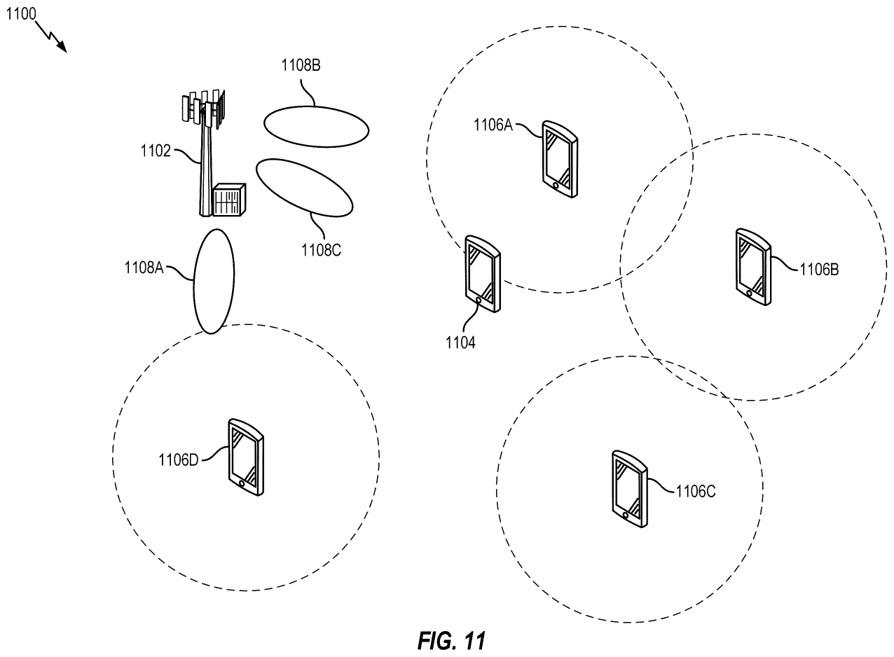

Additionally or alternatively, the prediction result 914 may include an indication of a beam associated with communications for the UE 904 (e.g., beam prediction). For example, if at some time in the past the first UE 904A received an indication from the second UE 904B that the second UE 904B is using a first beam to connect to the network entity 902 and now the first UE 904A receives an indication via the encoded information 912 in the signal 910 from the second UE 904B (e.g., a current nearby UE) that the second UE 904B is using a second beam to connect to the network entity 902, then the prediction result 914 may include an indication of the second beam, indicating that the first UE 904A also should likely use the second beam to connect to the network entity 902. The indication of the beam associated with communications for the UE 904 for the prediction result 914 is depicted and described in greater detail with respect to FIG. 11.

In some aspects, the first UE 904A may receive and/or obtain multiple signals from multiple additional UEs. Subsequently, the first UE 904A may filter out one or more signals from the multiple additional UEs based on measurements of the multiple signals. For example, the first UE 904A may measure an RSRP of each signal of the multiple signals. If the RSRP of a given signal does not meet or exceed a threshold value, the first UE 904A may not use the information encoded in that signal as an input to the ML model 906. Additionally or alternatively, the first UE 904A may input measurements of the multiple signals (e.g., RSRP measurements) into the ML model 906 to assist with determining the prediction result 914.

In some aspects, the network entity 902 may send control information 916 to the first UE 904A and the second UE 904B for enabling communication of the signal 910. For example, the network entity 902 may configure and indicate (e.g., via the control information 916) in which time and/or frequency resources that the second UE 904B can send the signal 910 and that the first UE 904A can monitor for the signal 910. In some aspects, the time and/or frequency resources indicated by the network entity 902 may include a pool of resources, and the second UE 904B may select a subset of the pool of resources for sending the signal 910, where the first UE 904A monitors across the entirety of the pool of resources for the signal 910. In some aspects, the network entity 902 may also indicate (e.g., via the control information 916 or other signaling) a transmit power to the second UE 904B for the second UE 904B to use for sending the signal 910. Additionally or alternatively, the transmit power for sending the signal 910 may be predefined (e.g., in wireless communications standards). In some aspects, the control information 916 may include an indication of a periodicity configured for the signal 910.

In some aspects, the network entity 902 may also indicate to the first UE 904A and the second UE 904B (e.g., via the control information 916 or other signaling) an association between one or more signal properties (e.g., intrinsic properties of the signal 910) and information encoded and/or conveyed via the signal 910. For example, the network entity 902 may indicate an association between different cyclic shifts or root sequence indexes that can be used for the signal 910 and what information can be encoded and/or conveyed via the signal 910 based on those different cyclic shifts or root sequence indexes. As an example, a first cyclic shift or first root sequence index may be associated with a first distance from a reference point or with a first beam, a second cyclic shift or second root sequence index may be associated with a second distance from the reference point or with a second beam, etc. Accordingly, the second UE 904B may select a cyclic shift and/or root sequence index based on the information it wants to encode and/or convey via the signal 910. Similarly, the first UE 904A may obtain the information encoded and/or conveyed via the signal 910 based on a detected cyclic shift and/or root sequence index of the signal 910.

In some aspects, the network entity 902 may indicate a reference location 918 to the first UE 904A and the second UE 904B to enable the positioning signaling (e.g., via the signal 910) and the positioning accuracy enhancement for the prediction result 914 of the ML model 906.

FIG. 10 depicts an example wireless communications network 1000 for a position prediction based on signaling via low-power transmitters in accordance with aspects of the present disclosure. In some examples, the wireless communications network 1000 may implement aspects of or may be implemented by aspects of FIG. 9. For example, the wireless communications network 1000 may include a network entity 1002, a first UE 1004, and one or more additional UEs 1006. The network entity 1002 may be an example of the network entity 902 depicted and described with respect to FIG. 9. The first UE 1004 may be an example of the first UE 904A depicted and described with respect to FIG. 9 (e.g., the first UE 1004 may include and/or employ an ML model, such as the ML model 906 depicted and described with respect to FIG. 9). The one or more additional UEs 1006 may be examples of the second UE 904B depicted and described with respect to FIG. 9 (e.g., the one or more additional UEs 1006 include low-power transmitters, such as the low-power transmitter 908 depicted and described with respect to FIG. 9).

In the example of FIG. 10, the first UE 1004 may obtain a predicted position for itself from an ML model based on signals obtained from the one or more additional UEs 1006, where the one or more additional UEs 1006 indicate positioning information of respective positions and/or locations for themselves by encoding that information in the signals (e.g., based on an association between one or more intrinsic properties of the signals and one or more types of information to be conveyed in the signals). For example, the one or more additional UEs 1006 may have determined their positions and/or locations already in the example of FIG. 10.

In some aspects, the positions and/or locations of the one or more additional UEs 1006 may be determined in relation to a reference location 1008 (e.g., indicated by the network entity 1002), For example, a first additional UE 1006A may determine it is located a first distance (e.g., 30 meters (m)) away from the reference location 1008, a second additional UE 1006B may determine it is located a second distance (e.g., 10 m) away from the reference location 1008, a third additional UE 1006C may determine it is located the first distance away from the reference location 1008, and a fourth additional UE 1006D may determine it is located a third distance (e.g., 100 m) away from the reference location 1008. In some aspects, the one or more additional UEs 1006 may have determined their positions and/or locations based on a downlink PRS 1010 sent by the network entity 1002. In some aspects, the one or more additional UEs 1006 may measure the downlink PRS 1010 and input the measurements into their own ML models to determine their positions and/or locations. Additionally or alternatively, the one or more additional UEs 1006 may determine their positions and/or locations based on the measurements alone.

Subsequently, each of the additional UEs 1006 may send (e.g., broadcast) indications of their respective distances away from the reference location 1008 (e.g., positioning information) via their low-power transmitters, and the first UE 1004 may obtain the indications (e.g., via encoded information in signaling from the additional UEs 1006 as described previously with respect to FIG. 9). Accordingly, the first UE 1004 may input the information of the respective distances for each of the additional UEs 1006 into its ML model to improve its positioning accuracy. In some aspects, the first UE 1004 may also input measurements of the downlink PRS 1010 into the ML model to further improve its positioning accuracy. For example, the ML model may output a predicted position for the first UE 1004 that is further from the reference location 1008 than the first distance for the first additional UE 1006A but closer to the reference location 1008 than the third distance for the fourth additional UE 1006D.

FIG. 11 depicts an example wireless communications network for a beam prediction based on signaling via low-power transmitters in accordance with aspects of the present disclosure. In some examples, the wireless communications network 1100 may implement aspects of or may be implemented by aspects of FIG. 9. For example, the wireless communications network 1100 may include a network entity 1102, a first UE 1104, and one or more additional UEs 1106. The network entity 1102 may be an example of the network entity 902 depicted and described with respect to FIG. 9. The first UE 1104 may be an example of the first UE 904A depicted and described with respect to FIG. 9 (e.g., the first UE 1104 may include and/or employ an ML model, such as the ML model 906 depicted and described with respect to FIG. 9). The one or more additional UEs 1106 may be examples of the second UE 904B depicted and described with respect to FIG. 9 (e.g., the one or more additional UEs 1106 include low-power transmitters, such as the low-power transmitter 908 depicted and described with respect to FIG. 9).

In the example of FIG. 11, the first UE 1104 may obtain an indication of a beam associated with communications for the first UE 1104 from an ML model based on signals obtained from the one or more additional UEs 1106, where the one or more additional UEs 1106 indicate beam management information of beams they used to connect to the network entity 1102 (e.g., and an indication of the network entity 1102) by encoding that information in the signals (e.g., based on an association between one or more intrinsic properties of the signals and one or more types of information to be conveyed in the signals). For example, the network entity 1102 may broadcast synchronization signals and/or other control information to enable UEs to establish a connection with the network entity 1102 via one or more beams 1108 (e.g., SSB beams), and each of the one or more additional UEs 1106 may connect to the network entity 1102 using information obtained from one of the beams 1108. In some aspects, the one or more beams 1108 may be transmit beams of the network entity 1102.

In the example of FIG. 11, the network entity 1102 transmit using a first beam 1108A, a second beam 1108B, and a third beam 1108C. A first additional UE 1106A may use the second beam 1108B to connect to the network entity 1102, a second additional UE 1106B may use the third beam 1108C to connect to the network entity 1102, a third additional UE 1106C may use the third beam 1108C to connect to the network entity 1102, and a fourth additional UE 1106D may use the first beam 1108A to connect to the network entity 1102. Subsequently, each of the additional UEs 1106 may send (e.g., broadcast) indications of their respective beams used to connect to the network entity 1102 (e.g., beam management information) via their low-power transmitters, and the first UE 1104 may obtain the indications (e.g., via encoded information in signaling from the additional UEs 1106 as described previously with respect to FIG. 9).

Accordingly, the first UE 1104 may input the information of the respective beams used to connect to the network entity 1102 for each of the additional UEs 1106 into its ML model for beam management and/or to obtain a beam prediction for connecting to the network entity 1102. For example, the ML model may output an indication of the third beam 1108C for the first UE 1104 to use to connect to the network entity 1102. In some aspects, the first UE 1104 may monitor for and measure signals obtained via the third beam 1108C. Subsequently, the first UE 1104 may send and/or report the measurements of the signals obtained via the third beam 1108C to the network entity 1102, and the network entity 1102 may use these measurements to determine parameters for subsequent communications with the first UE 1104 and/or to establish the connection between the network entity 1102 and the first UE 1104. That is, the indication of the third beam 1108C output by the ML model may correspond to a transmit beam of the network entity 1102 for which the first UE 1104 reports and/or sends measurements (e.g., for the third beam 1108C).

### Example Signaling of Encoded Information via Low-Power Transmitters for ML Models

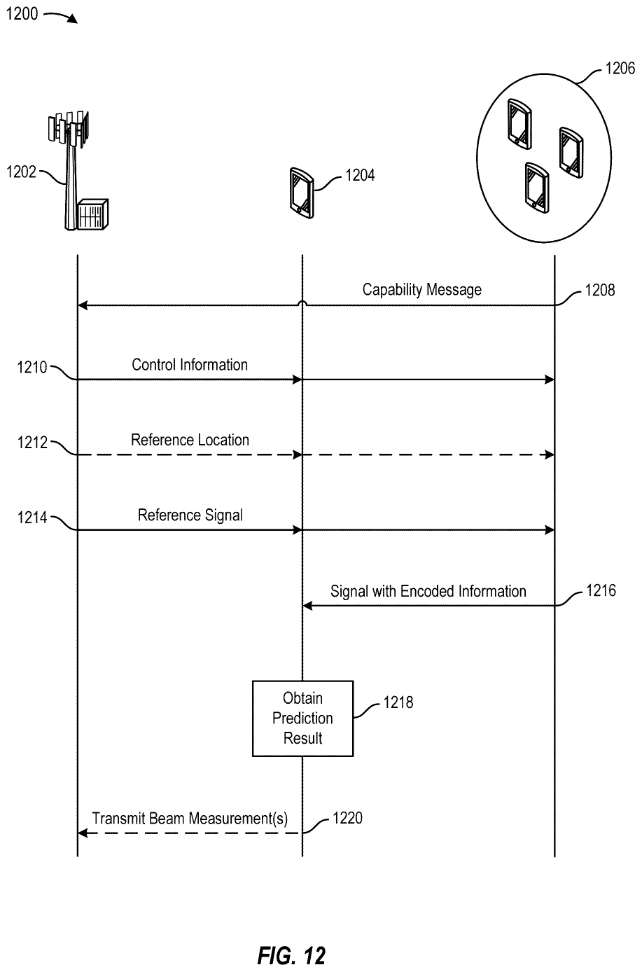

FIG. 12 depicts a process flow 1200 for communications in a network between a network entity 1202, a first UE 1204, and one or more additional UEs 1206. In some aspects, the network entity 1202 may be an example of the BS 102 depicted and described with respect to FIG. 1, the first network entity 300 or the second network entity 302 depicted and described with respect to FIG. 3, a disaggregated base station depicted and described with respect to FIG. 2, the network entity 902 depicted and described with respect to FIG. 9, the network entity 1002 depicted and described with respect to FIG. 10, or the network entity 1102 depicted and described with respect to FIG. 11. The first UE 1204 may be an example of UE 104 depicted and described with respect to FIG. 1, the UE 304 depicted and described with respect to FIG. 3, the first UE 904A depicted and described with respect to FIG. 9, the first UE 1004 depicted and described with respect to FIG. 10, or the first UE 1104 depicted and described with respect to FIG. 11. Similarly, the one or more additional UEs 1206 may be an example of UE 104 depicted and described with respect to FIG. 1, the UE 304 depicted and described with respect to FIG. 3, the second UE 904B depicted and described with respect to FIG. 9, the one or more additional UEs 1006 depicted and described with respect to FIG. 10, or the one or more additional UEs 1106 depicted and described with respect to FIG. 11. However, in other aspects, the first UE 1204 and the one or more additional UEs 1206 may be another type of wireless communications device, and network entity 1202 may be another type of network entity or network node, such as those described herein. Note that any operations or signaling illustrated with dashed lines may indicate that that operation or signaling is an optional or alternative example.

At 1208, the one or more additional UEs 1206 sends, and the network entity 1202 obtains, a message that includes one or more of: a capability of the one or more additional UEs 1206 to send signaling via a low-power transmitter (e.g., the low-power transmitter 908 depicted and described with respect to FIG. 9), or an indication that the one or more additional UEs 1206 are equipped with the low-power transmitter. For example, the one or more additional UEs 1206 may include a low-power transmitter and a main transmitter. In some aspects, the low-power transmitter may consume a first amount of power of the one or more additional UEs 1206 that is less than a second amount of power of the one or more additional UEs 1206 consumed by the main transmitter, and the low-power transmitter may include a first processor of the one or more additional UEs 1206 that has less capabilities than a second processor of the one or more additional UEs 1206 associated with the main transmitter.

At 1210, the network entity 1202 sends, and the first UE 1204 and the one or more additional UEs 1206 obtain, control information (e.g., the control information 916 depicted and described with respect to FIG. 9) that includes a plurality of time-frequency resources. In some aspects, the plurality of time-frequency resources may be configured for communication via the low-power transmitter. For example, the network entity 1202 may send the control information based on the message communicated at 1208. In some aspects, the control information may include an indication of one or more associations between one or more intrinsic properties of a signal and one or more types of information conveyed by the signal. In some aspects, the control information may include an indication of a transmit power for the communication via the low-power transmitters of the one or more additional UEs 1206. Additionally or alternatively, the transmit power for the communication via the low-power transmitters of the one or more additional UEs 1206 may be predefined.

At 1212, the network entity 1202 may send, and the first UE 1204 and the one or more additional UEs 1206 may obtain, an indication of a reference location (e.g., the indication of the reference location 918 depicted and described with respect to FIG. 9 and/or the reference location 1008 depicted and described a respect to FIG. 10).

At 1214, the network entity 1202 sends, and the first UE 1204 and the one or more additional UEs 1206 obtains, one or more reference signals. For example, the network entity 1202 may send, and the first UE 1204 and the one or more additional UEs 1206 may obtain, synchronization signaling sent via one or more transmit beams (e.g., the one or more beams 1108 depicted and described with respect to FIG. 11) of the network entity 1202. Additionally or alternatively, the network entity 1202 may send, and the first UE 1204 and the one or more additional UEs 1206 may obtain, a downlink PRS (e.g., the downlink PRS 1010 depicted and described with respect to FIG. 10).

At 1216, the one or more additional UEs 1206 send (e.g., via the low-power transmitter(s)), and the first UE 1204 obtains, a signal (e.g., the signal 910 depicted and described with respect to FIG. 9) that includes information, where the information is encoded in the signal (e.g., the encoded information 912 depicted and described with respect to FIG. 9) based on an intrinsic property of the signal. In some aspects, the information may include one or more of: beam management information (e.g., as depicted and described with respect to FIG. 11) or positioning information (e.g., as depicted and described with respect to FIG. 10). In some aspects, the signal may be obtained via one or more time-frequency resources of the plurality of time-frequency resources indicated in the control information at 1210. In some aspects, the one or more additional UEs 1206 may broadcast the signal according to a periodicity. For example, the network entity 1202 may send, and the first UE 1204 and/or the one or more additional UEs 1206 may obtain, an indication of a periodicity configured for the communication via the low-power transmitter(s) of the one or more additional UEs 1206. Additionally or alternatively, the periodicity may be predefined. In some aspects, the signal may include an unmodulated signal sent via the low-power transmitter(s) of the one or more additional UEs 1206.

In some aspects, the one or more additional UEs 1206 may send, and the first UE 1204 may obtain, a plurality of signals (e.g., from a plurality of UEs), where each signal of the plurality of signals includes respective information encoded in each signal based on respective intrinsic properties of each signal. Additionally or alternatively, each signal of the plurality of signals may include respective information associated with a different UE of the plurality of UEs. For example, each signal may include information corresponding to each different UE of the plurality of UEs, such as beam management information for each UE or positioning information for each UE.

In some aspects, the signal may include a sequence-based signal. For example, the sequence-based signal may include one or more of: a Zadoff-Chu sequence-based signal or a Golay sequence-based signal. In some aspects, the intrinsic property of the signal may include one or more of: a cyclic shift of the signal or a root sequence index value associated with the signal.

In some aspects, the signal may include information for the one or more additional UEs 1206 associated with the reference signal(s) communicated at 1214. For example, if the reference signal(s) include synchronization signaling obtained via one or more transmit beams of the network entity 1202, the information may include the beam management information, and the beam management information may include an indication of a transmit beam of the one or more transmit beams and an identifier associated with the network entity 1202. Additionally or alternatively, if the reference signal(s) include PRS(s), the information may include the positioning information, and the positioning information may include a position of the one or more additional UEs 1206. In some aspects, the one or more additional UEs 1206 may obtain the information to encode in the signal via an ML model.

At 1218, the first UE 1204 obtains, via an ML model (e.g., the ML model 906 depicted and described with respect to FIG. 9), a prediction result (e.g., the prediction result 914 depicted and described with respect to FIG. 9) based on the information, where the prediction result may include one or more of: an indication of a beam associated with communications for the first UE 1204 (e.g., as depicted and described with respect to FIG. 11) or a predicted position of the first UE 1204 (e.g., as depicted and described with respect to FIG. 10). For example, the information may include the beam management information, and the prediction result may include the indication of the beam associated with communications for the first UE 1204. Additionally or alternatively, the information may include the positioning information, and the prediction result may include the predicted position of the UE. In some aspects, the positioning information and the predicted position of the UE each include location information in relation to the reference location.

In some aspects, the first UE 1204 may obtain the prediction result via the ML model based on a subset of the respective information encoded in each signal, where the subset of the respective information is determined based on whether a power measurement (e.g., RSRP measurement) of each signal satisfies a power threshold value. Additionally or alternatively, the UE may obtain the prediction result via the ML model based on a power measurement (e.g., RSRP measurement) of the signal. In some aspects, the network entity 1202 may send, and the first UE 1204 may obtain, an additional signal (e.g., downlink PRS and/or other reference signal), where the prediction result is based on the information and the additional signal.

At 1220, the first UE 1204 may send, and the network entity 1202 may obtain, one or more measurements of a transmit beam associated with the network entity 1202, wherein the indication of the beam associated with communications for the first UE 1204 corresponds to the transmit beam. That is, the first UE 1204 may use the beam indicated by the prediction result to connect with the network entity 1202, which may include the first UE 1204 sending measurements of the beam indicated by the prediction result to the network entity 1202.

Note that the process flow illustrated in FIG. 12 is an example of an implementation of an ML model, and aspects of the present disclosure may be applied to signaling for enabling use of the ML model. Note that the process flow illustrated in FIG. 12 is described herein to facilitate an understanding of signaling via low-power transmitters for use with an ML model, and aspects of the present disclosure may be performed in various manners via alternative or additional signaling and/or operations. In certain aspects, the operations and/or signaling of FIG. 12 may occur in an order different from that described or depicted, and various actions, operations, and/or signaling may be added, omitted, or combined.

### Example Operations of a User Equipment

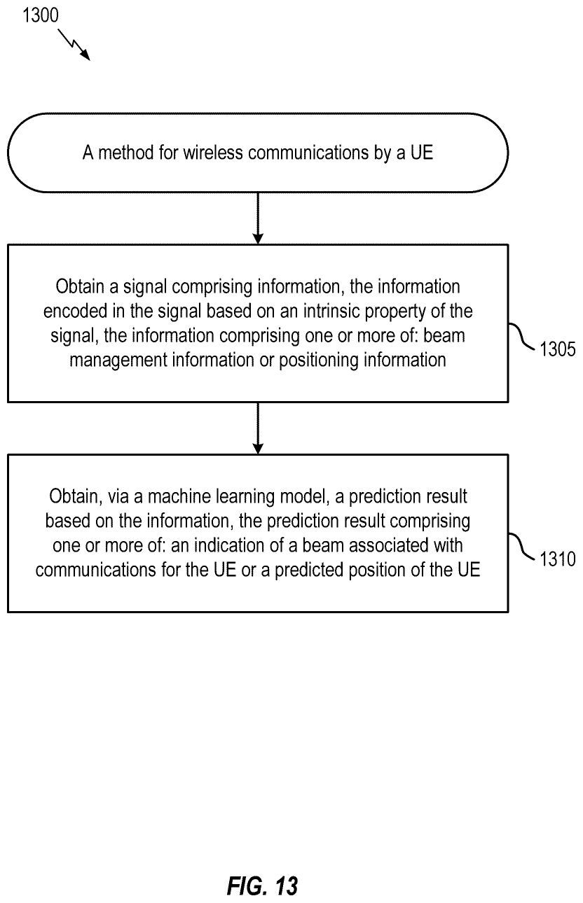

FIG. 13 shows a method 1300 for wireless communications by a UE, such as UE 104 depicted and described with respect to FIG. 1, UE 304 depicted and described with respect to FIG. 3, first UE 904A depicted and described with respect to FIG. 9, first UE 1004 depicted and described with respect to FIG. 10, first UE 1104 depicted and described with respect to FIG. 11, or first UE 1204 depicted and described with respect to FIG. 12.

Method 1300 begins at block 1305 with obtaining a signal (e.g., the signal 910 depicted and described with respect to FIG. 9) comprising information, the information encoded in the signal (e.g., the encoded information 912 depicted and described with respect to FIG. 9) based on an intrinsic property of the signal, the information comprising one or more of: beam management information (e.g., as depicted and described with respect to FIG. 11) or positioning information (e.g., as depicted and described with respect to FIG. 10).

Method 1300 then proceeds to block 1310 with obtaining, via a machine learning model (e.g., the ML model 906 depicted and described with respect to FIG. 9), a prediction result (e.g., the prediction result 914 depicted and described with respect to FIG. 9) based on the information, the prediction result comprising one or more of: an indication of a beam associated with communications for the UE (e.g., as depicted and described with respect to FIG. 11) or a predicted position of the UE (e.g., as depicted and described with respect to FIG. 10).

In some aspects, method 1300 further includes obtaining control information (e.g., the control information 916 depicted and described with respect to FIG. 9) comprising a plurality of time-frequency resources, wherein the signal is obtained via one or more time-frequency resources of the plurality of time-frequency resources.

In some aspects, the control information comprises an indication of one or more associations between one or more intrinsic properties of the signal and one or more types of information conveyed by the signal.

In some aspects, the signal comprises a sequence-based signal.

In some aspects, the sequence-based signal comprises one or more of: a Zadoff-Chu sequence-based signal or a Golay sequence-based signal.

In some aspects, the intrinsic property of the signal comprises one or more of: a cyclic shift of the signal or a root sequence index value associated with the signal.

In some aspects, the information comprises the beam management information, and the prediction result comprises the indication of the beam associated with communications for the UE.

In some aspects, method 1300 further includes sending, to a network entity, one or more measurements of a transmit beam associated with the network entity (e.g., the one or more beams 1108 depicted and described with respect to FIG. 11), wherein the indication of the beam associated with communications for the UE corresponds to the transmit beam.

In some aspects, the information comprises the positioning information, and the prediction result comprises the predicted position of the UE.

In some aspects, method 1300 further includes obtaining an indication of a reference location (e.g., the indication of the reference location 918 depicted and described with respect to FIG. 9 and/or the reference location 1008 depicted and described a respect to FIG. 10), wherein the positioning information and the predicted position of the UE each comprise location information in relation to the reference location.

In some aspects, method 1300 further includes obtaining a plurality of signals, each signal of the plurality of signals comprising respective information encoded in each signal based on respective intrinsic properties of each signal.

In some aspects, method 1300 further includes obtaining the prediction result via the machine learning model based on a subset of the respective information encoded in each signal, wherein the subset of the respective information is determined based on whether a power measurement of each signal satisfies a power threshold value.

In some aspects, method 1300 further includes obtaining the prediction result via the machine learning model based on a power measurement of the signal.

In some aspects, the signal comprising the information is obtained from an additional UE (e.g., the second UE 904B depicted and described with respect to FIG. 9, the one or more additional UEs 1006 depicted and described with respect to FIG. 10, the one or more additional UEs 1106 depicted and described with respect to FIG. 11, or the one or more additional UEs 1206 depicted and described with respect to FIG. 12).

In some aspects, method 1300 further includes obtaining, from a network entity, an additional signal (e.g., PRS(s), SSB(s), CSI-RS(s), etc.) wherein the prediction result is based on the information and the additional signal.

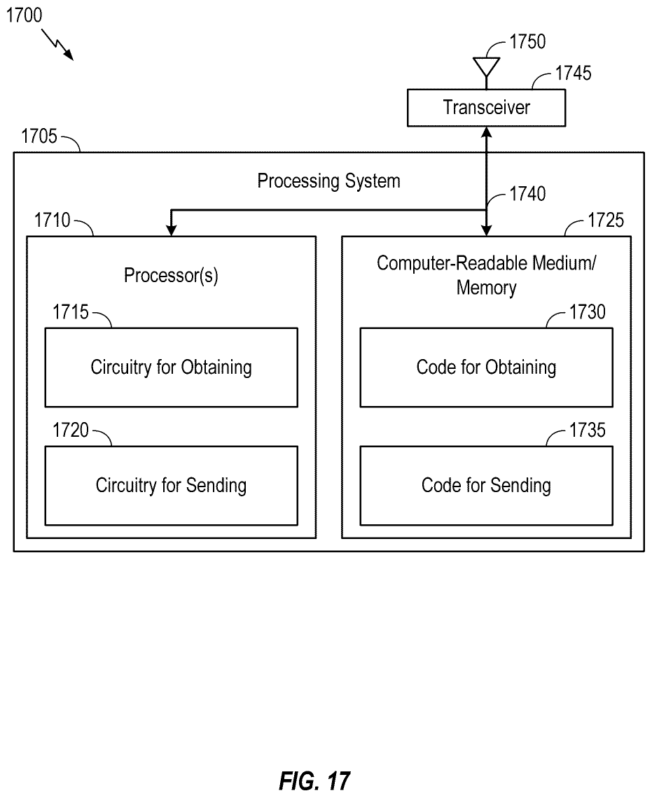

In some aspect, method 1300, or any aspect related to it, may be performed by an apparatus, such as communications device 1700 of FIG. 17, which includes various components operable, configured, or adapted to perform the method 1300. Communications device 1700 is described below in further detail.

Note that FIG. 13 is just one example of a method, and other methods including fewer, additional, or alternative operations are possible consistent with this disclosure.

In certain aspects, method 1300 may be performed by the apparatus to realize one or more technical effects or solutions to the aforementioned technical problem(s). For example, based on method 1300, signaling, such as via low-power transmitters, may be defined for obtaining a prediction result from an ML model of the apparatus. The techniques for obtaining a prediction result from the ML model (e.g., based on the signaling via the low-power transmitters) may enable improved wireless communications performance at the apparatus (e.g., employing the ML model), such as reduced latency and increased throughput. For example, the prediction result from the ML model may include an indication of a beam associated with communications for the apparatus based on the signaling, where using the beam from the indication may result in reduced latency and/or increased throughput for the apparatus. Additionally or alternatively, the prediction result from the ML model may include a predicted position of the apparatus, which may enhance and/or enable different technologies for the apparatus, such as IoT systems, autonomous driving, etc.

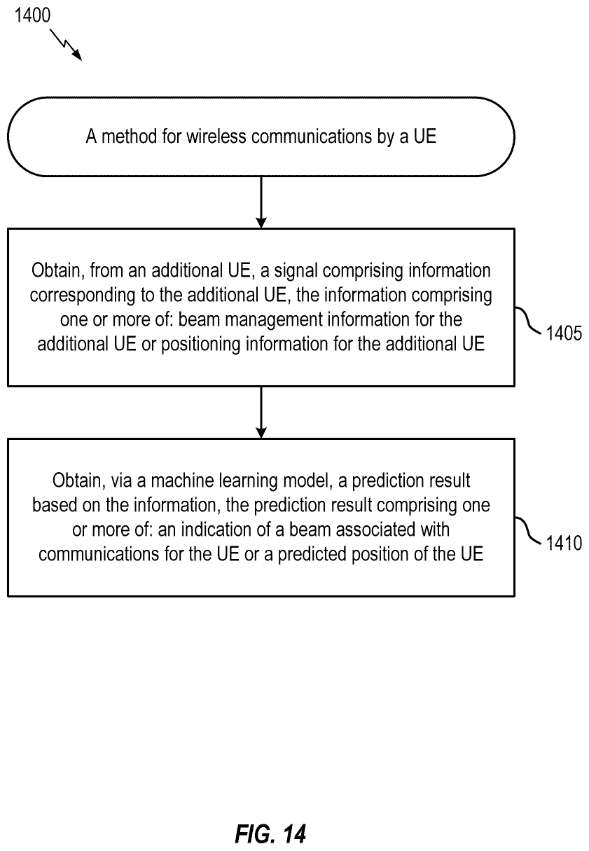

FIG. 14 shows a method 1400 for wireless communications by a UE, such as UE 104 depicted and described with respect to FIG. 1, UE 304 depicted and described with respect to FIG. 3, first UE 904A depicted and described with respect to FIG. 9, first UE 1004 depicted and described with respect to FIG. 10, first UE 1104 depicted and described with respect to FIG. 11, or first UE 1204 depicted and described with respect to FIG. 12.

Method 1400 begins at block 1405 with obtaining, from an additional UE (e.g., the second UE 904B depicted and described with respect to FIG. 9, the one or more additional UEs 1006 depicted and described with respect to FIG. 10, the one or more additional UEs 1106 depicted and described with respect to FIG. 11, or the one or more additional UEs 1206 depicted and described with respect to FIG. 12), a signal (e.g., the signal 910 depicted and described with respect to FIG. 9) comprising information corresponding to the additional UE, the information comprising one or more of: beam management information for the additional UE (e.g., as depicted and described with respect to FIG. 11) or positioning information for the additional UE (e.g., as depicted and described with respect to FIG. 10).

Method 1400 then proceeds to block 1410 with obtaining, via a machine learning model (e.g., the ML model 906 depicted and described with respect to FIG. 9), a prediction result (e.g., the prediction result 914 depicted and described with respect to FIG. 9) based on the information, the prediction result comprising one or more of: an indication of a beam associated with communications for the UE (e.g., as depicted and described with respect to FIG. 11) or a predicted position of the UE (e.g., as depicted and described with respect to FIG. 10).

In some aspects, method 1400 further includes obtaining control information (e.g., the control information 916 depicted and described with respect to FIG. 9) comprising a plurality of time-frequency resources, wherein the signal is obtained via one or more time-frequency resources of the plurality of time-frequency resources.

In some aspects, the control information comprises an indication of one or more associations between one or more intrinsic properties of the signal and one or more types of information conveyed by the signal.

In some aspects, the signal comprises a sequence-based signal, and the information corresponding to the additional UE is encoded in the sequence-based signal (e.g., the encoded information 912 depicted and described with respect to FIG. 9) based on an intrinsic property of the sequence-based signal.

In some aspects, the sequence-based signal comprises one or more of: a Zadoff-Chu sequence-based signal or a Golay sequence-based signal.

In some aspects, the intrinsic property of the sequence-based signal comprises one or more of: a cyclic shift of the sequence-based signal or a root sequence index value associated with the sequence-based signal.

In some aspects, the information comprises the beam management information, and the prediction result comprises the indication of the beam associated with communications for the UE.

In some aspects, method 1400 further includes sending, to a network entity, one or more measurements of a transmit beam associated with the network entity (e.g., the one or more beams 1108 depicted and described with respect to FIG. 11), wherein the indication of the beam associated with communications for the UE corresponds to the transmit beam.

In some aspects, the information comprises the positioning information, and the prediction result comprises the predicted position of the UE.

In some aspects, method 1400 further includes obtaining an indication of a reference location (e.g., the indication of the reference location 918 depicted and described with respect to FIG. 9 and/or the reference location 1008 depicted and described a respect to FIG. 10), wherein the positioning information and the predicted position of the UE each comprise location information in relation to the reference location.

In some aspects, method 1400 further includes obtaining a plurality of signals from a plurality of UEs, each signal of the plurality of signals comprising respective information associated with a different UE of the plurality of UEs.

In some aspects, method 1400 further includes obtaining the prediction result via the machine learning model based on a subset of the respective information, wherein the subset of the respective information is determined based on whether a power measurement of each signal satisfies a power threshold value.

In some aspects, method 1400 further includes obtaining the prediction result via the machine learning model based on a power measurement of the signal.

In some aspects, method 1400 further includes obtaining, from a network entity, an additional signal (e.g., PRS(s), SSB(s), CSI-RS(s), etc.), wherein the prediction result is based on the information and the additional signal.

In some aspect, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative operations are possible consistent with this disclosure.

In certain aspects, method 1400 may be performed by the apparatus to realize one or more technical effects or solutions to the aforementioned technical problem(s). For example, based on method 1400, signaling, such as from additional UEs, may be defined for obtaining a prediction result from an ML model of the apparatus. The techniques for obtaining a prediction result from the ML model (e.g., based on the signaling via the low-power transmitters) may enable improved wireless communications performance at the apparatus (e.g., employing the ML model), such as reduced latency and increased throughput. For example, the prediction result from the ML model may include an indication of a beam associated with communications for the apparatus based on the signaling from the additional UEs, where using the beam from the indication may result in reduced latency and/or increased throughput for the apparatus. Additionally or alternatively, the prediction result from the ML model may include a predicted position of the apparatus based on the signaling from the additional UEs, which may enhance and/or enable different technologies for the apparatus, such as IoT systems, autonomous driving, etc.

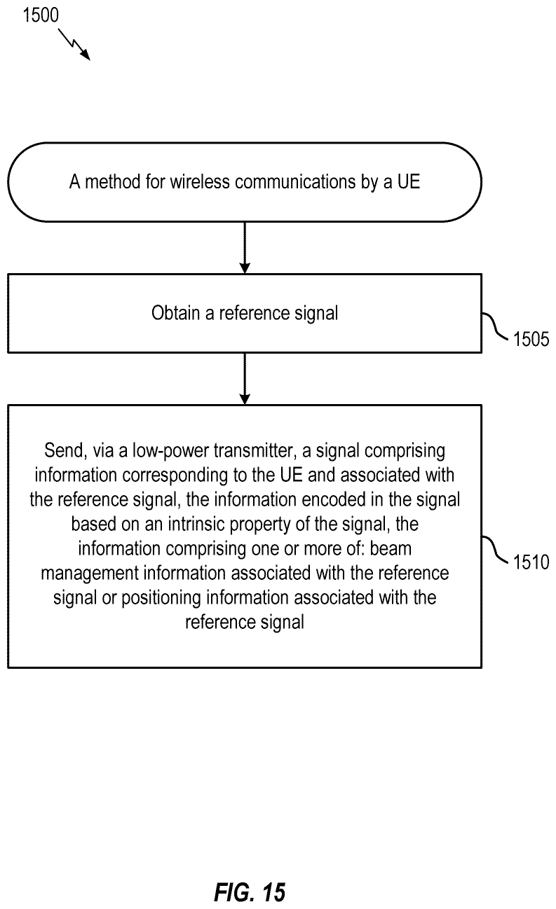

FIG. 15 shows a method 1500 for wireless communications by a UE, such as UE 104 depicted and described with respect to FIG. 1, UE 304 depicted and described with respect to FIG. 3, second UE 904B depicted and described with respect to FIG. 9, the one or more additional UEs 1006 depicted and described with respect to FIG. 10, the one or more additional UEs 1106 depicted and described with respect to FIG. 11, or the one or more additional UEs 1206 depicted and described with respect to FIG. 12.

Method 1500 begins at block 1505 with obtaining a reference signal (e.g., synchronization signal(s)/SSB(s), PRS(s), CSI-RS(s), etc.).

Method 1500 then proceeds to block 1510 with sending, via a low-power transmitter (e.g., the low-power transmitter 908 depicted and described with respect to FIG. 9), a signal (e.g., the signal 910 depicted and described with respect to FIG. 9) comprising information corresponding to the UE and associated with the reference signal, the information encoded in the signal (e.g., the encoded information 912 depicted and described with respect to FIG. 9) based on an intrinsic property of the signal, the information comprising one or more of: beam management information associated with the reference signal (e.g., as depicted and described with respect to FIG. 11) or positioning information associated with the reference signal (e.g., as depicted and described with respect to FIG. 10).

In some aspects, method 1500 further includes sending a message comprising one or more of: a capability of the UE to send signaling via the low-power transmitter, or an indication that the UE is equipped with the low-power transmitter.

In some aspects, method 1500 further includes obtaining, based on the message, control information (e.g., the control information 916 depicted and described with respect to FIG. 9) comprising a plurality of time-frequency resources configured for communication via the low-power transmitter, wherein the signal is sent via one or more time-frequency resources of the plurality of time-frequency resources.

In some aspects, the control information comprises an indication of one or more associations between one or more intrinsic properties of the signal and one or more types of information conveyed by the signal.

In some aspects, the control information comprises an indication of a transmit power for the signal.

In some aspects, the signal comprises a sequence-based signal.

In some aspects, the sequence-based signal comprises one or more of: a Zadoff-Chu sequence-based signal or a Golay sequence-based signal.

In some aspects, the intrinsic property of the signal comprises one or more of: a cyclic shift of the signal or a root sequence index value associated with the signal.

In some aspects, the reference signal comprises synchronization signaling obtained via one or more transmit beams of a network entity (e.g., the one or more beams 1108 depicted and described with respect to FIG. 11), the information comprises the beam management information, and the beam management information comprises an indication of a transmit beam of the one or more transmit beams and an identifier associated with the network entity.

In some aspects, the reference signal comprises a positioning reference signal (e.g., the downlink PRS 1010 depicted and described with respect to FIG. 10), the information comprises the positioning information, and the positioning information comprises a position of the UE determined based on the positioning reference signal.

In some aspects, method 1500 further includes obtaining an indication of a reference location (e.g., the indication of the reference location 918 depicted and described with respect to FIG. 9 and/or the reference location 1008 depicted and described a respect to FIG. 10), wherein the position of the UE is indicated in relation to the reference location.

In some aspects, method 1500 further includes obtaining, via a machine learning model, the information to encode in the signal.

In some aspects, method 1500 further includes broadcasting the signal according to a periodicity.

In some aspects, the signal comprises an unmodulated signal sent via the low-power transmitter.

In some aspects, a transmit power for the signal is predefined.

In some aspects, the UE comprises: the low-power transmitter; and a main transmitter, wherein: the low-power transmitter consumes a first amount of power of the UE that is less than a second amount of power of the UE consumed by the main transmitter, and the low-power transmitter comprises a first processor of the UE that has less capabilities than a second processor of the UE associated with the main transmitter.

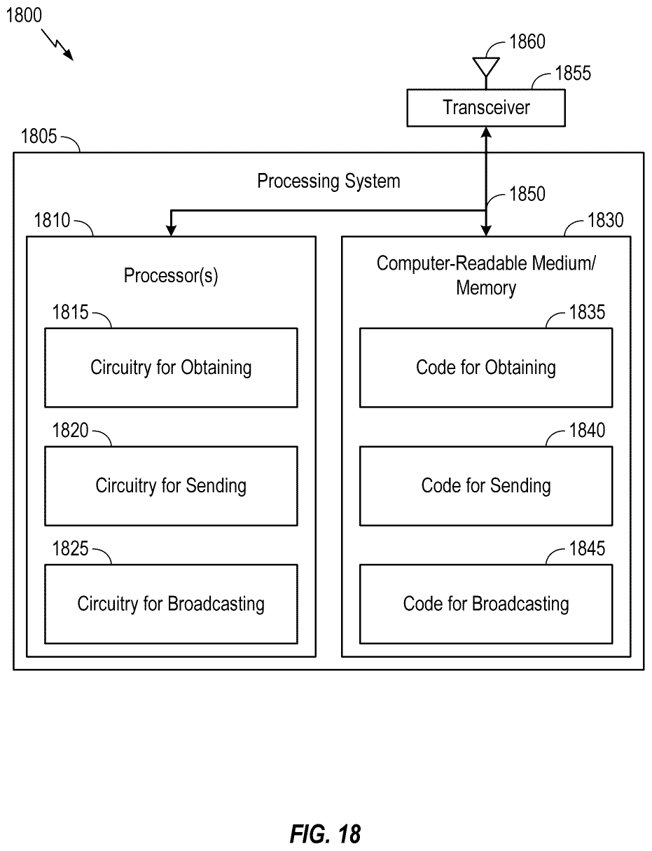

In some aspect, method 1500, or any aspect related to it, may be performed by an apparatus, such as communications device 1800 of FIG. 18, which includes various components operable, configured, or adapted to perform the method 1500. Communications device 1800 is described below in further detail.

Note that FIG. 15 is just one example of a method, and other methods including fewer, additional, or alternative operations are possible consistent with this disclosure.

In certain aspects, method 1500 may be performed by the apparatus to realize one or more technical effects or solutions to the aforementioned technical problem(s). For example, based on method 1500, signaling, such as via a low-power transmitter of the apparatus, may be defined for producing a prediction result from an ML model of a UE. The techniques for signaling may enable improved wireless communications performance, such as reduced power consumption at the apparatus. For example, generating such signaling may consume less power at the apparatus compared to complex signaling.

### Example Operations of a Network Entity

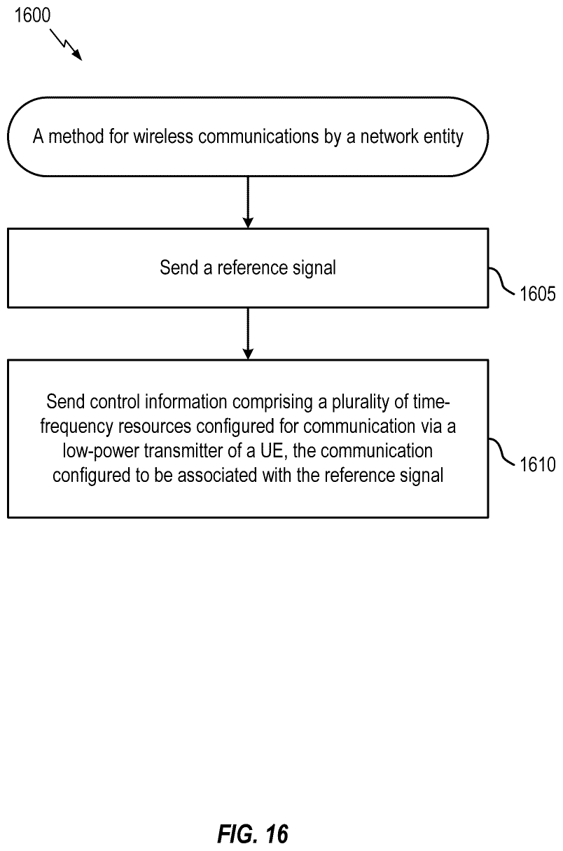

FIG. 16 shows a method 1600 for wireless communications by a network entity, such as BS 102 depicted and described with respect to FIG. 1, first network entity 300 or second network entity 302 depicted and described with respect to FIG. 3, a disaggregated base station depicted and described with respect to FIG. 2, network entity 902 depicted and described with respect to FIG. 9, network entity 1002 depicted and described with respect to FIG. 10, network entity 1102 depicted and described with respect to FIG. 11, or network entity 1202 depicted and described with respect to FIG. 12.

Method 1600 begins at block 1605 with sending a reference signal (e.g., synchronization signal(s)/SSB(s), PRS(s), CSI-RS(s), etc.).

Method 1600 then proceeds to block 1610 with sending control information (e.g., the control information 916 depicted and described with respect to FIG. 9) comprising a plurality of time-frequency resources configured for communication via a low-power transmitter of a UE (e.g., the low-power transmitter 908 depicted and described with respect to FIG. 9), the communication configured to be associated with the reference signal.

In certain aspects, method 1600 further includes obtaining a message comprising one or more of: a capability of the UE to send the communication via the low-power transmitter, or an indication that the UE is equipped with the low-power transmitter.

In certain aspects, method 1600 further includes sending the control information based on the message.

In some aspects, the control information comprises an indication of one or more associations between one or more intrinsic properties of the communication and one or more types of information conveyed by the communication.

In some aspects, the communication comprises sequence-based signaling, and the one or more intrinsic properties of the communication comprises one or more of: a cyclic shift of the sequence-based signaling or a root sequence index value associated with the sequence-based signaling.

In some aspects, the control information comprises an indication of a transmit power for the communication via the low-power transmitter of the UE.

In some aspects, the reference signal comprises synchronization signaling sent via one or more transmit beams of the network entity (e.g., the one or more beams 1108 depicted and described with respect to FIG. 11), and the communication is configured to be associated with the synchronization signaling.

In some aspects, the reference signal comprises a positioning reference signal (e.g., the downlink PRS 1010 depicted and described with respect to FIG. 10), the communication is configured to be associated with the positioning reference signal.

In certain aspects, method 1600 further includes sending an indication of a reference location (e.g., the indication of the reference location 918 depicted and described with respect to FIG. 9 and/or the reference location 1008 depicted and described a respect to FIG. 10), wherein the positioning reference signal is associated with the reference location.

In certain aspects, method 1600 further includes sending an indication of a periodicity configured for the communication.

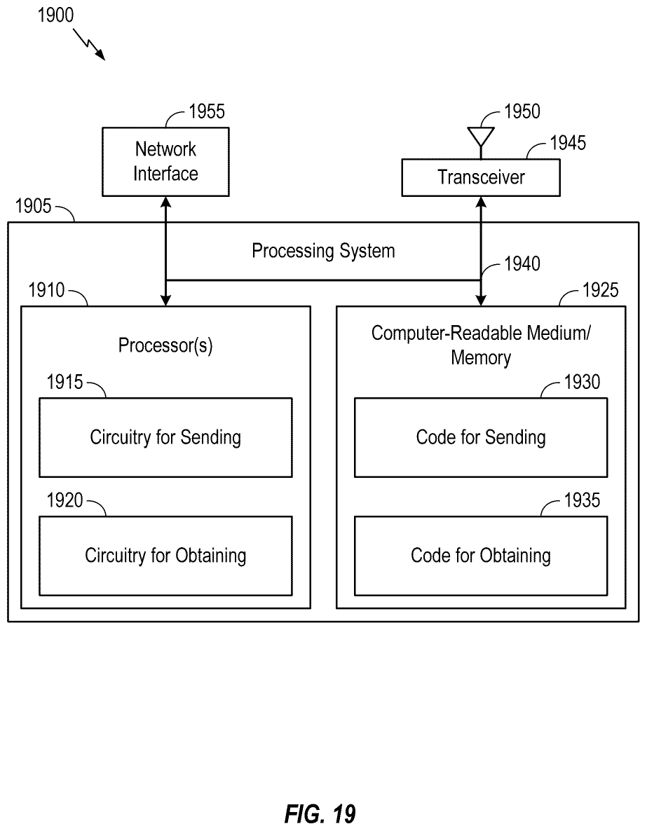

In some aspect, method 1600, or any aspect related to it, may be performed by an apparatus, such as communications device 1900 of FIG. 19, which includes various components operable, configured, or adapted to perform the method 1600. Communications device 1900 is described below in further detail.

Note that FIG. 16 is just one example of a method, and other methods including fewer, additional, or alternative operations are possible consistent with this disclosure.

In certain aspects, method 1600 may be performed by the apparatus to realize one or more technical effects or solutions to the aforementioned technical problem(s). For example, based on method 1600, signaling, such as via low-power transmitters, may be defined for obtaining a prediction result from an ML model of a UE. The techniques for signaling may enable improved wireless communications performance, such as reduced power consumption at UEs that are sending the signaling. For example, generating such signaling may consume less power at the UEs compared to complex signaling. Additionally or alternatively, the techniques for obtaining a prediction result from the ML model (e.g., based on the signaling via the low-power transmitters) may enable improved wireless communications performance at a UE employing the ML model, such as reduced latency and increased throughput. For example, the prediction result from the ML model may include an indication of a beam associated with communications for the UE employing the ML model based on the signaling, where using the beam from the indication may result in reduced latency and/or increased throughput for the UE. Additionally or alternatively, the prediction result from the ML model may include a predicted position of the UE based on the signaling, which may enhance and/or enable different technologies for the UE, such as IoT systems, autonomous driving, etc. Accordingly, the apparatus may configure and/or indicate control information to enable the signaling for use with the ML model of the UE.

### Example Communications Device

FIG. 17 depicts aspects of an example communications device 1700 configured for wireless communications. In some aspects, communications device 1700 is a user equipment, such as UE 104 described above with respect to FIG. 1 or UE 304 described with respect to FIG. 3.

The communications device 1700 includes a processing system 1705 coupled to a transceiver 1745 (e.g., a transmitter and/or a receiver). The transceiver 1745 is configured to transmit and receive signals for the communications device 1700 via an antenna 1750, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1725. In various aspects, the one or more processors 1710 may be representative of the one or more processors 318 described with respect to FIG. 3. The one or more processors 1710 are coupled to a computer-readable medium/memory 1725 via a bus 1740. In some aspects, the computer-readable medium/memory 1725 may be representative of the one or more memories 320 described with respect to FIG. 3. The computer-readable medium/memory 1725 is a non-transitory computer-readable medium/memory. In certain aspects, the computer-readable medium/memory 1725 is configured to store instructions (e.g., computer-executable code), that when executed by the one or more processors 1710, cause the one or more processors 1710 to perform the method 1300 described with respect to FIG. 13, or any aspect related to it, including any operations described in relation to FIG. 13; and the method 1400 described with respect to FIG. 14, or any aspect related to it, including any operations described in relation to FIG. 14. Note that reference to a processor performing a function of communications device 1700 may include one or more processors performing that function of communications device 1700, such as in a distributed fashion.

In the depicted example, computer-readable medium/memory 1725 stores code (e.g., executable instructions), including code for obtaining 1730 and code for sending 1735. Processing of the code 1730 and 1735 may enable and cause the communications device 1700 to perform the method 1300 described with respect to FIG. 13, or any aspect related to it; and the method 1400 described with respect to FIG. 14, or any aspect related to it. For instance, in some aspects, code for obtaining 1730 includes code for obtaining a signal comprising information, the information encoded in the signal based on an intrinsic property of the signal, the information comprising one or more of: beam management information or positioning information. In some aspects, code for obtaining 1730 includes code for obtaining, via a machine learning model, a prediction result based on the information, the prediction result comprising one or more of: an indication of a beam associated with communications for the UE or a predicted position of the UE.

In some aspects, code for obtaining 1730 includes code for obtaining, from an additional UE, a signal comprising information corresponding to the additional UE, the information comprising one or more of: beam management information for the additional UE or positioning information for the additional UE. In some aspects, code for obtaining 1730 includes code for obtaining, via a machine learning model, a prediction result based on the information, the prediction result comprising one or more of: an indication of a beam associated with communications for the UE or a predicted position of the UE.

The one or more processors 1710 include circuitry configured to implement (e.g., execute) the code stored in the computer-readable medium/memory 1725, including circuitry for obtaining 1715 and circuitry for sending 1720. Processing with circuitry 1715 and 1720 may enable and cause the communications device 1700 to perform the method 1300 described with respect to FIG. 13, or any aspect related to it; and the method 1400 described with respect to FIG. 14, or any aspect related to it. For instance, in some aspects, circuitry for obtaining 1715 includes circuitry for obtaining a signal comprising information, the information encoded in the signal based on an intrinsic property of the signal, the information comprising one or more of: beam management information or positioning information. In some aspects, circuitry for obtaining 1715 includes circuitry for obtaining, via a machine learning model, a prediction result based on the information, the prediction result comprising one or more of: an indication of a beam associated with communications for the UE or a predicted position of the UE.

In some aspects, circuitry for obtaining 1715 includes circuitry for obtaining, from an additional UE, a signal comprising information corresponding to the additional UE, the information comprising one or more of: beam management information for the additional UE or positioning information for the additional UE. In some aspects, circuitry for obtaining 1715 includes circuitry for obtaining, via a machine learning model, a prediction result based on the information, the prediction result comprising one or more of: an indication of a beam associated with communications for the UE or a predicted position of the UE.

More generally, means for communicating, transmitting, sending or outputting for transmission may include the one or more transceivers 324, one or more antenna 322 and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17.

FIG. 18 depicts aspects of an example communications device 1800 configured for wireless communications. In some aspects, communications device 1800 is a user equipment, such as UE 104 described above with respect to FIG. 1 or UE 304 described with respect to FIG. 3.

The communications device 1800 includes a processing system 1805 coupled to a transceiver 1855 (e.g., a transmitter and/or a receiver). The transceiver 1855 is configured to transmit and receive signals for the communications device 1800 via an antenna 1860, such as the various signals as described herein. The processing system 1805 may be configured to perform processing functions for the communications device 1800, including processing signals received and/or to be transmitted by the communications device 1800.

The processing system 1805 includes one or more processors 1810 and a computer-readable medium/memory 1830. In various aspects, the one or more processors 1810 may be representative of the one or more processors 318 described with respect to FIG. 3. The one or more processors 1810 are coupled to a computer-readable medium/memory 1830 via a bus 1850. In some aspects, the computer-readable medium/memory 1830 may be representative of the one or more memories 320 described with respect to FIG. 3. The computer-readable medium/memory 1830 is a non-transitory computer-readable medium/memory. In certain aspects, the computer-readable medium/memory 1830 is configured to store instructions (e.g., computer-executable code), that when executed by the one or more processors 1810, cause the one or more processors 1810 to perform the method 1500 described with respect to FIG. 15, or any aspect related to it, including any operations described in relation to FIG. 15. Note that reference to a processor performing a function of communications device 1800 may include one or more processors performing that function of communications device 1800, such as in a distributed fashion.

In the depicted example, computer-readable medium/memory 1830 stores code (e.g., executable instructions), including code for obtaining 1835, code for sending 1840, and code for broadcasting 1845. Processing of the code 1835-1845 may enable and cause the communications device 1800 to perform the method 1500 described with respect to FIG. 15, or any aspect related to it. For instance, in some aspects, code for obtaining 1835 includes code for obtaining a reference signal. In some aspects, code for sending 1840 includes code for sending, via a low-power transmitter, a signal comprising information corresponding to the UE and associated with the reference signal, the information encoded in the signal based on an intrinsic property of the signal, the information comprising one or more of: beam management information associated with the reference signal or positioning information associated with the reference signal.

The one or more processors 1810 include circuitry configured to implement (e.g., execute) the code stored in the computer-readable medium/memory 1830, including circuitry for obtaining 1815, circuitry for sending 1820, and circuitry for broadcasting 1825. Processing with circuitry 1815-1825 may enable and cause the communications device 1800 to perform the method 1500 described with respect to FIG. 15, or any aspect related to it. For instance, in some aspects, circuitry for obtaining 1815 includes circuitry for obtaining a reference signal. In some aspects, circuitry for sending 1820 includes circuitry for sending, via a low-power transmitter, a signal comprising information corresponding to the UE and associated with the reference signal, the information encoded in the signal based on an intrinsic property of the signal, the information comprising one or more of: beam management information associated with the reference signal or positioning information associated with the reference signal.

More generally, means for communicating, transmitting, sending, broadcasting or outputting for transmission may include the one or more transceivers 324, one or more antenna 322 and/or processing system 316 of the UE 304 illustrated in FIG. 3 transceiver 1855 and/or antenna 1860 of the communications device 1800 in FIG. 18, and/or one or more processors 1810 of the communications device 1800 in FIG. 18. Means for communicating, receiving or obtaining may include the one or more transceivers 324, one or more antennas 322, and/or processing system 316 of the UE 304 illustrated in FIG. 3, transceiver 1855 and/or antenna 1860 of the communications device 1800 in FIG. 18, and/or one or more processors 1810 of the communications device 1800 in FIG. 18.

FIG. 19 depicts aspects of an example communications device configured for wireless communications. In some aspects, communications device 1900 is a network entity, such as BS 102 of FIG. 1, first network entity 300 or second network entity 302 of FIG. 3, or a disaggregated base station as discussed with respect to FIG. 2.

The communications device 1900 includes a processing system 1905 coupled to a transceiver 1945 (e.g., a transmitter and/or a receiver) and/or a network interface 1955. The transceiver 1945 is configured to transmit and receive signals for the communications device 1900 via an antenna 1950, such as the various signals as described herein. The network interface 1955 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910 and a computer-readable medium/memory 1925. In various aspects, one or more processors 1910 may be representative of the one or more processors 308, as described with respect to FIG. 3. The one or more processors 1910 are coupled to the computer-readable medium/memory 1925 via a bus 1940. In certain aspects, the computer-readable medium/memory 1925 is configured to store instructions (e.g., computer-executable code), including code 1930 and 1935, that when executed by the one or more processors 1910, cause the one or more processors 1910 to perform the method 1600 described with respect to FIG. 16, or any aspect related to it, including any operations described in relation to FIG. 16. The computer-readable medium/memory 1925 is a non-transitory computer-readable medium/memory. Note that reference to a processor of communications device 1900 performing a function may include one or more processors of communications device 1900 performing that function, such as in a distributed fashion.

In the depicted example, the computer-readable medium/memory 1925 stores code (e.g., executable instructions), including code for sending 1930 and code for obtaining 1935. Processing of the code 1930 and 1935 may enable and cause the communications device 1900 to perform the method 1600 described with respect to FIG. 16, or any aspect related to it. For instance, in some aspects, code for sending 1930 includes code for sending a reference signal. In some aspects, code for sending 1930 includes code for sending control information comprising a plurality of time-frequency resources configured for communication via a low-power transmitter of a UE, the communication configured to be associated with the reference signal.

The one or more processors 1910 include circuitry configured to implement (e.g., execute) the code stored in the computer-readable medium/memory 1925, including circuitry for sending 1915 and circuitry for obtaining 1920. Processing with circuitry 1915 and 1920 may enable and cause the communications device 1900 to perform the method 1600 described with respect to FIG. 16, or any aspect related to it. For instance, in some aspects, circuitry for sending 1915 includes circuitry for sending a reference signal. In some aspects, circuitry for sending 1915 includes circuitry for sending control information comprising a plurality of time-frequency resources configured for communication via a low-power transmitter of a UE, the communication configured to be associated with the reference signal.

Various components of the communications device 1900 may provide means for performing the method 1600 described with respect to FIG. 16, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1945, antenna 1950, and/or network interface 1955 of the communications device 1900 in FIG. 19, and/or one or more processors 1910 of the communications device 1900 in FIG. 19. Means for communicating, receiving or obtaining may include the one or more transceivers 312, one or more antennas 314, and/or processing system 306 of the first network entity 300 or the second network entity 302 illustrated in FIG. 3, transceiver 1945, antenna 1950, and/or network interface 1955 of the communications device 1900 in FIG. 19, and/or one or more processors 1910 of the communications device 1900 in FIG. 19.

### EXAMPLE CLAUSES

Implementation examples are described in the following numbered clauses:

Clause 1: A method for wireless communications by a UE comprising: obtaining a signal comprising information, the information encoded in the signal based on an intrinsic property of the signal, the information comprising one or more of: beam management information or positioning information; and obtaining, via a machine learning model, a prediction result based on the information, the prediction result comprising one or more of: an indication of a beam associated with communications for the UE or a predicted position of the UE.

Clause 2: The method of Clause 1, further comprising obtaining control information comprising a plurality of time-frequency resources, wherein the signal is obtained via one or more time-frequency resources of the plurality of time-frequency resources.

Clause 3: The method of Clause 2, wherein the control information comprises an indication of one or more associations between one or more intrinsic properties of the signal and one or more types of information conveyed by the signal.

Clause 4: The method of any one of Clauses 1-3, wherein the signal comprises a sequence-based signal.

Clause 5: The method of Clause 4, wherein the sequence-based signal comprises one or more of: a Zadoff-Chu sequence-based signal or a Golay sequence-based signal.

Clause 6: The method of Clause 4, wherein the intrinsic property of the signal comprises one or more of: a cyclic shift of the signal or a root sequence index value associated with the signal.

Clause 7: The method of any one of Clauses 1-6, wherein: the information comprises the beam management information, and the prediction result comprises the indication of the beam associated with communications for the UE.

Clause 8: The method of Clause 7, further comprising sending, to a network entity, one or more measurements of a transmit beam associated with the network entity, wherein the indication of the beam associated with communications for the UE corresponds to the transmit beam.

Clause 9: The method of any one of Clauses 1-8, wherein: the information comprises the positioning information, and the prediction result comprises the predicted position of the UE.

Clause 10: The method of Clause 9, further comprising obtaining an indication f a reference location, wherein the positioning information and the predicted position of the UE each comprise location information in relation to the reference location.

Clause 11: The method of any one of Clauses 1-10, further comprising obtaining a plurality of signals, each signal of the plurality of signals comprising respective information encoded in each signal based on respective intrinsic properties of each signal.

Clause 12: The method of Clause 11, further comprising obtaining the prediction result via the machine learning model based on a subset of the respective information encoded in each signal, wherein the subset of the respective information is determined based on whether a power measurement of each signal satisfies a power threshold value.

Clause 13: The method of any one of Clauses 1-12, further comprising obtaining the prediction result via the machine learning model based on a power measurement of the signal.

Clause 14: The method of any one of Clauses 1-13, wherein the signal comprising the information is obtained from an additional UE.

Clause 15: The method of Clause 14, further comprising obtaining, from a network entity, an additional signal, wherein the prediction result is based on the information and the additional signal.

Clause 16: A method for wireless communications by a UE comprising: obtaining, from an additional UE, a signal comprising information corresponding to the additional UE, the information comprising one or more of: beam management information for the additional UE or positioning information for the additional UE; and obtaining, via a machine learning model, a prediction result based on the information, the prediction result comprising one or more of: an indication of a beam associated with communications for the UE or a predicted position of the UE.

Clause 17: The method of Clause 16, further comprising obtaining control information comprising a plurality of time-frequency resources, wherein the signal is obtained via one or more time-frequency resources of the plurality of time-frequency resources.

Clause 18: The method of Clause 17, wherein the control information comprises an indication of one or more associations between one or more intrinsic properties of the signal and one or more types of information conveyed by the signal.

Clause 19: The method of any one of Clauses 16-18, wherein: the signal comprises a sequence-based signal, and the information corresponding to the additional UE is encoded in the sequence-based signal based on an intrinsic property of the sequence-based signal.

Clause 20: The method of Clause 19, wherein the sequence-based signal comprises one or more of: a Zadoff-Chu sequence-based signal or a Golay sequence-based signal.

Clause 21: The method of Clause 19, wherein the intrinsic property of the sequence-based signal comprises one or more of: a cyclic shift of the sequence-based signal or a root sequence index value associated with the sequence-based signal.

Clause 22: The method of any one of Clauses 16-21, wherein: the information comprises the beam management information, and the prediction result comprises the indication of the beam associated with communications for the UE.

Clause 23: The method of Clause 22, further comprising sending, to a network entity, one or more measurements of a transmit beam associated with the network entity, wherein the indication of the beam associated with communications for the UE corresponds to the transmit beam.

Clause 24: The method of any one of Clauses 16-23, wherein: the information comprises the positioning information, and the prediction result comprises the predicted position of the UE.

Clause 25: The method of Clause 24, further comprising obtaining an indication of a reference location, wherein the positioning information and the predicted position of the UE each comprise location information in relation to the reference location.

Clause 26: The method of any one of Clauses 16-25, further comprising obtaining a plurality of signals from a plurality of UEs, each signal of the plurality of signals comprising respective information associated with a different UE of the plurality of UEs.

Clause 27: The method of Clause 26, further comprising obtaining the prediction result via the machine learning model based on a subset of the respective information, wherein the subset of the respective information is determined based on whether a power measurement of each signal satisfies a power threshold value.

Clause 28: The method of any one of Clauses 16-27, further comprising obtaining the prediction result via the machine learning model based on a power measurement of the signal.

Clause 29: The method of any one of Clauses 16-28, further comprising obtaining, from a network entity, an additional signal, wherein the prediction result is based on the information and the additional signal.

Clause 30: A method for wireless communications by a UE comprising: obtaining a reference signal; and sending, via a low-power transmitter, a signal comprising information corresponding to the UE and associated with the reference signal, the information encoded in the signal based on an intrinsic property of the signal, the information comprising one or more of: beam management information associated with the reference signal or positioning information associated with the reference signal.

Clause 31: The method of Clause 30, further comprising sending a message comprising one or more of: a capability of the UE to send signaling via the low-power transmitter, or an indication that the UE is equipped with the low-power transmitter.

Clause 32: The method of Clause 31, further comprising obtaining, based on the message, control information comprising a plurality of time-frequency resources configured for communication via the low-power transmitter, wherein the signal is sent via one or more time-frequency resources of the plurality of time-frequency resources.

Clause 33: The method of Clause 32, wherein the control information comprises an indication of one or more associations between one or more intrinsic properties of the signal and one or more types of information conveyed by the signal.

Clause 34: The method of Clause 32, wherein the control information comprises an indication of a transmit power for the signal.

Clause 35: The method of any one of Clauses 30-34, wherein the signal comprises a sequence-based signal.

Clause 36: The method of Clause 35, wherein the sequence-based signal comprises one or more of: a Zadoff-Chu sequence-based signal or a Golay sequence-based signal.

Clause 37: The method of Clause 35, wherein the intrinsic property of the signal comprises one or more of: a cyclic shift of the signal or a root sequence index value associated with the signal.

Clause 38: The method of any one of Clauses 30-37, wherein: the reference signal comprises synchronization signaling obtained via one or more transmit beams of a network entity, the information comprises the beam management information, and the beam management information comprises an indication of a transmit beam of the one or more transmit beams and an identifier associated with the network entity.

Clause 39: The method of any one of Clauses 30-38, wherein: the reference signal comprises a positioning reference signal, the information comprises the positioning information, and the positioning information comprises a position of the UE determined based on the positioning reference signal.

Clause 40: The method of Clause 39, further comprising obtaining an indication of a reference location, wherein the position of the UE is indicated in relation to the reference location.

Clause 41: The method of any one of Clauses 30-40, further comprising obtaining, via a machine learning model, the information to encode in the signal.

Clause 42: The method of any one of Clauses 30-41, further comprising broadcasting the signal according to a periodicity.

Clause 43: The method of any one of Clauses 30-42, wherein the signal comprises an unmodulated signal sent via the low-power transmitter.

Clause 44: The method of any one of Clauses 30-43, wherein a transmit power for the signal is predefined.

Clause 45: The method of any one of Clauses 30-44, wherein the UE comprises: the low-power transmitter; and a main transmitter, wherein: the low-power transmitter consumes a first amount of power of the UE that is less than a second amount of power of the UE consumed by the main transmitter, and the low-power transmitter comprises a first processor of the UE that has less capabilities than a second processor of the UE associated with the main transmitter.

Clause 46: A method for wireless communications by a network entity comprising: sending a reference signal; and sending control information comprising a plurality of time-frequency resources configured for communication via a low-power transmitter of a UE, the communication configured to be associated with the reference signal.

Clause 47: The method of Clause 46, further comprising obtaining a message comprising one or more of: a capability of the UE to send the communication via the low-power transmitter, or an indication that the UE is equipped with the low-power transmitter.

Clause 48: The method of Clause 47, further comprising sending the control information based on the message.

Clause 49: The method of any one of Clauses 46-48, wherein the control information comprises an indication of one or more associations between one or more intrinsic properties of the communication and one or more types of information conveyed by the communication.

Clause 50: The method of Clause 49, wherein: the communication comprises sequence-based signaling, and the one or more intrinsic properties of the communication comprises one or more of: a cyclic shift of the sequence-based signaling or a root sequence index value associated with the sequence-based signaling.

Clause 51: The method of any one of Clauses 46-50, wherein the control information comprises an indication of a transmit power for the communication via the low-power transmitter of the UE.

Clause 52: The method of any one of Clauses 46-51, wherein: the reference signal comprises synchronization signaling sent via one or more transmit beams of the network entity, and the communication is configured to be associated with the synchronization signaling.

Clause 53: The method of any one of Clauses 46-52, wherein: the reference signal comprises a positioning reference signal, the communication is configured to be associated with the positioning reference signal.

Clause 54: The method of Clause 53, further comprising sending an indication of a reference location, wherein the positioning reference signal is associated with the reference location.

Clause 55: The method of any one of Clauses 46-54, further comprising sending an indication of a periodicity configured for the communication.

Clause 56: One or more apparatuses, comprising: one or more memories comprising executable instructions; and one or more processors configured to execute the executable instructions and cause the one or more apparatuses to perform a method in accordance with any one of Clauses 1-55.

Clause 57: One or more apparatuses configured for wireless communications, comprising: one or more memories; and one or more processors, coupled to the one or more memories, configured to cause the one or more apparatuses to perform a method in accordance with any one of Clauses 1-55.

Clause 58: One or more apparatuses configured for wireless communications, comprising: one or more memories; and one or more processors, coupled to the one or more memories, configured to perform a method in accordance with any one of Clauses 1-55.

Clause 59: One or more apparatuses, comprising means for performing a method in accordance with any one of Clauses 1-55.

Clause 60: One or more non-transitory computer-readable media comprising executable instructions that, when executed by one or more processors of one or more apparatuses, cause the one or more apparatuses to perform a method in accordance with any one of Clauses 1-55.

Clause 61: One or more computer program products embodied on one or more computer-readable storage media comprising code for performing a method in accordance with any one of Clauses 1-55.

Clause 62: One or more apparatuses configured for wireless communications, comprising: a processing system that includes one or more processors and one or more memories coupled with the one or more processors, the processing system configured to cause the one or more apparatuses to perform a method in accordance with any one of Clauses 1-55.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain a signal comprising information, the information encoded in the signal based on an intrinsic property of the signal, the information comprising one or more of: beam management information or positioning information; and
obtain, via a machine learning model, a prediction result based on the information, the prediction result comprising one or more of: an indication of a beam associated with communications for the UE or a predicted position of the UE.

2. The apparatus of claim 1, wherein the processing system is configured to cause the UE to obtain control information comprising a plurality of time-frequency resources, wherein the signal is obtained via one or more time-frequency resources of the plurality of time-frequency resources.

3. The apparatus of claim 2, wherein the control information comprises an indication of one or more associations between one or more intrinsic properties of the signal and one or more types of information conveyed by the signal.

4. The apparatus of claim 1, wherein the signal comprises a sequence-based signal.

5. The apparatus of claim 4, wherein the sequence-based signal comprises one or more of: a Zadoff-Chu sequence-based signal or a Golay sequence-based signal.

6. The apparatus of claim 4, wherein the intrinsic property of the signal comprises one or more of: a cyclic shift of the signal or a root sequence index value associated with the signal.

7. The apparatus of claim 1, wherein:
the information comprises the beam management information, and
the prediction result comprises the indication of the beam associated with communications for the UE.

8. The apparatus of claim 7, wherein the processing system is configured to cause the UE to send, to a network entity, one or more measurements of a transmit beam associated with the network entity, wherein the indication of the beam associated with communications for the UE corresponds to the transmit beam.

9. The apparatus of claim 1, wherein:
the information comprises the positioning information, and the prediction result comprises the predicted position of the UE.

10. The apparatus of claim 9, wherein the processing system is configured to cause the UE to obtain an indication of a reference location, wherein the positioning information and the predicted position of the UE each comprise location information in relation to the reference location.

11. The apparatus of claim 1, wherein the processing system is configured to cause the UE to obtain a plurality of signals, each signal of the plurality of signals comprising respective information encoded in each signal based on respective intrinsic properties of each signal.

12. The apparatus of claim 11, wherein the processing system is configured to cause the UE to obtain the prediction result via the machine learning model based on a subset of the respective information encoded in each signal, wherein the subset of the respective information is determined based on whether a power measurement of each signal satisfies a power threshold value.

13. The apparatus of claim 1, wherein the processing system is further configured to cause the UE to obtain the prediction result via the machine learning model based on a power measurement of the signal.

14. The apparatus of claim 1, wherein the signal comprising the information is obtained from an additional UE.

15. The apparatus of claim 14, wherein the processing system is configured to cause the UE to obtain, from a network entity, an additional signal, wherein the prediction result is based on the information and the additional signal.

16. An apparatus for wireless communications, comprising a processing system that includes one or more processors and one or more memories coupled with the one or more processors, the processing system configured to cause a user equipment (UE) to:
obtain a reference signal; and
send, via a low-power transmitter, a signal comprising information corresponding to the UE and associated with the reference signal, the information encoded in the signal based on an intrinsic property of the signal, the information comprising one or more of: beam management information associated with the reference signal or positioning information associated with the reference signal.

17. The apparatus of claim 16, wherein the processing system is configured to cause the UE to send a message comprising one or more of:
a capability of the UE to send signaling via the low-power transmitter, or an indication that the UE is equipped with the low-power transmitter.

18. The apparatus of claim 16, wherein the processing system is configured to cause the UE to obtain, via a machine learning model, the information to encode in the signal.

19. The apparatus of claim 16, wherein the signal comprises an unmodulated signal sent via the low-power transmitter.

20. An apparatus for wireless communications, comprising a processing system that includes one or more processors and one or more memories coupled with the one or more processors, the processing system configured to cause a network entity to:
send a reference signal; and
send control information comprising a plurality of time-frequency resources configured for communication via a low-power transmitter of a user equipment (UE), the communication configured to be associated with the reference signal.
